(19) United States
(12) Patent Application Publication
(10) Pub. No.: US 2025/0100585 A1
(43) Pub. Date: Mar. 27, 2025

(54) METHODS AND SYSTEM RELATING TO NAVIGATION, POWER GENERATION AND SENSORS FOR VEHICLES

(71) Applicant: Peter Yeung, Ottawa (CA)

(72) Inventor: Peter Yeung, Ottawa (CA)

(21) Appl. No.: 18/518,556

(22) PCT Filed: May 26, 2022
(86) PCT No.: PCT/CA2022/050838

§ 371 Date: Nov. 23, 2023

Related U.S. Application Data
(60) Provisional application No. 63/193,063, filed on May 26, 2021.
(60) Provisional application No. 63/221,485, filed on Jul. 14, 2021.
(60) Provisional application No. 63/229,492, filed on Aug. 4, 2021.
(60) Provisional application No. 63/288,607, filed on Dec. 12, 2021.
(60) Provisional application No. 63/316,354, filed on Mar. 3, 2022.
(60) Provisional application No. 63/318,348, filed on Mar. 9, 2022.
(60) Provisional application No. 63/320,513, filed on Mar. 16, 2022.

(51) Int. Cl. B60W 60/00; B60L 58/12; G08G 1/0968

(52) U.S. Cl. CPC B60W 60/0023; B60L 58/12; G08G 1/096805

(57) ABSTRACT

As vehicles evolve from fully-manual through to fully autonomous they face a range of issues that will impact their performance, acceptance, and range of applications. Prior art driving assistance system (DAS) and advanced DAS (ADAS) target steering and lane keeping. However, the requirements for semi-autonomous and autonomous vehicles (SAAVs) extend beyond these to dynamic traffic updates, roadside information, real time network control, etc. as well as replenishing station location identification, access and navigation etc. Accordingly, it would be beneficial to provide semi-autonomous and autonomous vehicles and infrastructure providers with means to support enhanced navigation and control functionality for semi-autonomous and autonomous vehicles without requiring costly and time-consuming infrastructure upgrades.

### CROSS-REFERENCE TO RELATED APPLICATIONS

This patent application claims the benefit of priority as a 371 National Phase Entry application of PCT/CA2022/050838 filed 26 May 2022; which claims the benefit of priority from U.S. Provisional Patent Application 63/193,063 filed May 26, 2021; it also claims the benefit of priority from U.S. Provisional Patent Application 63/221,485 filed Jul. 14, 2021; it also claims the benefit of priority from U.S. Provisional Patent Application 63/229,492 filed Aug. 4, 2021; it also claims the benefit of priority from U.S. Provisional Patent Application 63/288,607 filed Dec. 12, 2021; it also claims the benefit of priority from U.S. Provisional Patent Application 63/316,354 filed Mar. 3, 2022; it also claims the benefit of priority from U.S. Provisional Patent Application 63/318,348 filed Mar. 9, 2022; it also claims the benefit of priority from U.S. Provisional Patent Application 63/320,513 filed Mar. 16, 2022.

### FIELD OF THE INVENTION

This patent application relates to vehicles and more particularly to methods and systems relating to vehicles for improved semi-autonomous or autonomous navigation, electrical power generation and enhanced protection and cleaning of sensors associated with the vehicle.

### BACKGROUND OF THE INVENTION

Today the majority of vehicles are controlled by a driver. A range of driver assistance features are now commonly available, including for example, in-vehicle navigation systems to provide the driver with directions to a preset destination, cruise control for automated speed maintenance, adaptive cruise control that maintains speed but adjusts if the vehicle comes up behind a slower moving vehicle, lane keeping assistance which provides automatic steering and/or braking to keep a vehicle in its travel lane, lane departure warning, road departure warning, and lane centering assist. To date autonomous vehicles have been primarily limited to deployment in highly controlled environments such as moving materials around preset paths within a factory.

However, the evolution of driver assistance is towards semi-autonomous vehicles and autonomous vehicles. Today there are approximately 1.2 billion vehicles globally which is anticipated to increase to 2.5 billion by 2050. By 2025 the projection is for approximately 8 million autonomous or semi-autonomous vehicles on the road, approximately 0.67%, with this increasing over time. However, autonomous vehicles, in addition to addressing existing applications such as passenger transport, bulk transport etc. are also expected to open up additional applications such as direct deliveries to residences, businesses etc. of small loads or discrete items, etc.

The Society of Automotive Engineers (SAE) defines 6 levels of driving automation ranging from 0 (fully manual) to 5 (fully autonomous). These being:
Level 0 with a driver providing the “dynamic driving task” although there may be systems in place to help the driver such as an emergency braking system for example;
Level 1 with a driving assistance system (DAS) such as for steering or accelerating;
Level 2 which is referred to as advanced driver assistance systems (ADAS) where the vehicle can control steering and accelerating/decelerating but falls short of self-driving because the driver still sits in the driver's seat and can take control of the vehicle at any time;
Level 3 is conditional driving automation wherein the vehicle has “environmental detection” capabilities and can make informed decisions but still requires driver override;
Level 4 or high driving automation where the vehicle can adapt if things go wrong or there is a system failure and does not require driver interaction in most circumstances. However, until legislation and infrastructure evolve, they can only do so within a limited area with limited speeds by geofencing; and
Level 5 or full driving automation where the “dynamic driving task” is eliminated and these vehicles will not be geofenced and can do anything that an experienced human driver can do.

As vehicles evolve through these levels and operate, they face a range of issues that will impact their performance, acceptance, and range of applications. Within the prior art the focus to date has been primarily to establishing vision based systems for DAS and ADAS to provide functions such as steering and lane keeping for example with Light Detection and Ranging (LIDAR)/Radar for adaptive cruise control etc. However, even these systems have limited use today under many environmental scenarios such as low light, rain, snow, ice etc. such that these DAS/ADAS features are already only intermittently available for significant periods of time in many regions of the world where today traffic density is high and the number of vehicles significant. Accordingly, it would be beneficial to provide vehicle designers with enhancements that increase the availability of the requisite sensors to these DAS/ADAS systems and supporting the evolving requirements of semi-autonomous and autonomous vehicles for sensors and sensor uptime.

Similarly, automated systems within the prior art to provide dynamic traffic updates, roadside information etc. either require that these are provided through a wireless network or require significant infrastructure upgrades to provide the required communications, sensors, etc. For example, global positioning systems or even terrestrial wireless system have limited penetration underground, within parking structures, within tunnels etc. and cannot provide the requisite degree of precision in many instances to address the requirements such as parking, maneuvering etc. Further, in the United States alone there are 4 million miles of road requiring enhancements under some prior art schemes before even considering private roads, driveways, off road driving, etc. Accordingly, it would be beneficial to provide semi-autonomous and autonomous vehicles and infrastructure providers with means to support enhanced navigation and control functionality for semi-autonomous and autonomous vehicles without requiring costly and time-consuming infrastructure upgrades.

Further, all of these systems within semi-autonomous and autonomous vehicles require electrical power. Today, for example, a Tesla 3 LR battery pack weights approximately 460 kg (approximately 1,000 lbs) to provide a vehicle range of approximately 525 km (approximately 325 miles). Considering, the evolution of small delivery vehicles, single person semi-autonomous and autonomous vehicles etc. then lighter/smaller vehicles will place power constraints on the electronics and the drive train. Accordingly, it would be beneficial to provide means to generate electrical power for the control systems during the vehicles operation.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to vehicles and more particularly to methods and systems relating to vehicles for improved semi-autonomous or autonomous navigation, electrical power generation and enhanced protection and cleaning of sensors associated with the vehicle.

In accordance with an embodiment of the invention there is provided a method of defining a region of a surface for traversal by a vehicle comprising:
providing a plurality of markers in a predetermined pattern upon the surface;
determining by an electronic device forming part of the vehicle the region of the surface in dependence upon processing signals received from a subset of the plurality of markers; wherein
the signals received from the subset of the plurality of markers are received by a receiver forming part of the vehicle.

In accordance with an embodiment of the invention there is provided a vehicle comprising:
a first battery system for providing electricity to a motor of the vehicle;
a second battery system coupled to an electrical control system of the vehicle; wherein
upon determining with the electrical control system the first battery system has dropped below a predetermined charge threshold establishing an action of the electrical control system with respect to the vehicle.

In accordance with an embodiment of the invention there is provided a vehicle comprising:
a first battery system for providing electricity to a motor of the vehicle;
a plurality of second battery systems where each second battery system of the plurality of second battery systems is coupled to an electrical control system of a plurality of electrical control systems of the vehicle; wherein
upon determining the first battery system has dropped below a predetermined charge threshold establishing one or more actions with a subset of the plurality of electrical control systems.

In accordance with an embodiment of the invention there is provided a method of generating electricity for a vehicle comprising:
providing one or more at least one of air collectors and air concentrators each comprising an inlet and an outlet;
providing an air turbine electrical generator coupled to the outlets of the one or more at least one of air collectors and air concentrators; wherein
air flow through the one or more at least one of air collectors and air concentrators generates electrical power for the vehicle via the air turbine electrical generator.

In accordance with an embodiment of the invention there is provided a method of recharging a semi-autonomous or autonomous vehicle (SAAV) comprising:
determining arrival of the SAAV within the vicinity of a plurality of replenishing stations supporting recharging of the SAAV;
broadcasting a first message from the SAAV indicating that SAAV requirements for recharging;
identifying, with an electronic device associated with the plurality of replenishing stations an identity of a specific replenishing station of the plurality of replenishing stations that can provide the requirements of the SAAV which is currently empty of a SAAV;
transmitting a message from the replenishing station comprising data relating to the specific replenishing station the plurality of replenishing stations; and
automatically navigating the SAAV to the specified replenishing station location then updates the status of the replenishing station so that it does not provide it to another vehicle until it has verified that the SAAV has recharged and departed

In accordance with an embodiment of the invention there is provided a method of recharging a semi-autonomous or autonomous vehicle (SAAV) comprising:
determining arrival of the SAAV within the vicinity of a plurality of replenishing stations supporting recharging of the SAAV;
broadcasting data to the SAAV from an electronic device associated with the plurality of replenishing stations;
identifying, with another electronic device associated with the SAAV an identity of a specific replenishing station of the plurality of replenishing stations that can fulfil a requirement of the SAAV for recharging;
transmitting a message from the SAAV to the specific replenishing station the plurality of replenishing stations to reserve a charging slot at the specific replenishing station the plurality of replenishing stations; and
automatically navigating the SAAV to the specified replenishing station location then updates the status of the replenishing station so that it does not provide it to another vehicle until it has verified that the SAAV has recharged and departed.

In accordance with an embodiment of the invention there is provided a container based replenishing station for a vehicle comprising:
a source of fuel to replenish the vehicle;
an electronic device coupled to a network for providing data to a remote server; and
a plurality of markers; wherein
the plurality of markers are employed by the vehicle to maneuver into a correct position such that the vehicle can replenish with the fuel.

In accordance with an embodiment of the invention there is provided a method of navigating a vehicle comprising:
providing an active device associated with a location within which the vehicle will navigate;
transmitting to the vehicle from the active device a navigation file associated with the location; and
navigating the vehicle within the location in dependence upon data within the navigation file.

In accordance with an embodiment of the invention there is provided a module for a vehicle comprising:
at least one of a sensor and a transceiver;
an air deflector comprising an inlet and an outlet; wherein
the outlet of the air deflector directs air flow existing the outlet to impact upon the at least one of a sensor and a transceiver to remove at least one of dust, water, and debris from the At least one of a sensor and a transceiver; and
each air deflector of the one or more air deflectors increases a velocity of air from the inlet to the outlet.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary network environment within which configurable electrical devices according to and supporting embodiments of the invention may be deployed and operate; and

FIG. 2 depicts an exemplary wireless portable electronic device supporting communications to a network such as depicted in FIG. 1 and configurable electrical devices according to and supporting embodiments of the invention;

FIG. 3 depicts a vehicle according to an embodiment of the invention denoting locations of air inlets for turbine power generators;

FIG. 4 depicts a block diagram of a vehicle with an RF transmitter based for navigating the vehicle with respect to markers upon a surface the vehicle is moving across at a replenishing station;

FIG. 5 depicts a schematic of multiple RF transceivers upon a vehicle for implementing the navigation according to FIG. 4;

FIG. 6 depicts the system according to FIGS. 4 and 5 for navigating the vehicle within multiple lanes at a replenishing station;

FIG. 7 depicts a block diagram illustrating a system according to an embodiment of the invention for implementing the navigation according to FIGS. 4 and 5;

FIGS. 8A and 8B depict associating multiple markers with different replenishing stations according to an embodiment of the invention;

FIG. 9 depicts exemplary portable replenishing stations according to embodiments of the invention;

FIG. 10 depicts an image of parking environments not supported by prior art navigation systems;

FIG. 11 depicts an active device for providing data to a vehicle prior to its navigation within an environment not supported by prior art navigation systems;

FIG. 12 depicts road infrastructure elements, temporary or fixed, with which active devices for providing data to vehicles prior to their navigation within an environment not supported by prior art navigation systems may be associated;

FIG. 13 depicts images of complex multi-layer intersections not supported by prior art navigation systems;

FIGS. 14 and 15 depict exemplary air flow deflectors for cleaning sensors and/or transceivers of debris according to an embodiment of the invention;

FIG. 16 depicts a replaceable sheet for protecting a sensor and/or transceiver from debris according to an embodiment of the invention;

FIG. 17 depicts a replaceable filter for protecting a sensor and/or transceiver from debris according to an embodiment of the invention;

FIG. 18 depicts a thin film heater for protecting a sensor and/or transceiver from debris according to an embodiment of the invention; and

FIG. 19 depicts a wiper system for clearing debris according to an embodiment of the invention.

### DETAILED DESCRIPTION

The present invention is directed to vehicles and more particularly to methods and systems relating to vehicles for improved semi-autonomous or autonomous navigation, electrical power generation and enhanced protection and cleaning of sensors associated with the vehicle.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers, or groups thereof and that the terms are not to be construed as specifying components, features, steps, or integers. Likewise, the phrase “consisting essentially of,” and grammatical variants thereof, when used herein is not to be construed as excluding additional components, steps, features integers or groups thereof but that the additional features, integers, steps, components, or groups thereof do not materially alter the basic and novel characteristics of the claimed composition, device or method. If the specification or claims refer to “an additional” element, that does not preclude there being more than one of the additional element.

A “wireless standard” as used herein and throughout this disclosure, refer to, but is not limited to, a standard for transmitting signals and/or data through electromagnetic radiation which may be optical, radio frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device, and an electronic reader.

A “fixed electronic device” (FED) as used herein may refer to, but is not limited to, a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein may refer to, but is not limited to, one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application,” an element of a “software suite,” a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men, and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” as used herein may refer to, but is not limited to, a miniature electronic device or devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed, or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g., digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein may refer to, but is not limited to, a computer and/or microprocessor readable data file comprising data relating to settings and/or limits of an adult device. Such profiles may be established by a manufacturer/supplier/provider of a device, service, etc. or they may be established by a user through a user interface for a device, a service, or a PED/FED in communication with a device, another device, a server, or a service provider etc.

A “computer file” (commonly known as a file) as used herein, and throughout this disclosure, refers to a computer resource for recording data discretely in a computer storage device, this data being electronic content. A file may be defined by one of several types of computer files, designed for different purposes. A file may be designed to store electronic content such as a written message, a video, a computer program, or a wide variety of other kinds of data. Some types of files can store several types of information at once. A file can be opened, read, modified, copied, and closed with one or more software applications an arbitrary number of times. Typically, files are organized in a file system which can be used on numerous diverse types of storage device exploiting different kinds of media which keeps track of where the files are located on the storage device(s) and enables user access. The format of a file is defined by its content since a file is solely a container for data, although, on some platforms the format is usually indicated by its filename extension, specifying the rules for how the bytes must be organized and interpreted meaningfully. For example, the bytes of a plain text file are associated with either ASCII or UTF-8 characters, while the bytes of image, video, and audio files are interpreted otherwise. Some file types also allocate a few bytes for metadata, which allows a file to carry some basic information about itself.

“Metadata” as used herein, and throughout this disclosure, refers to information stored as data that provides information about other data. Many distinct types of metadata exist, including but not limited to, descriptive metadata, structural metadata, administrative metadata, reference metadata and statistical metadata. Descriptive metadata may describe a resource for purposes such as discovery and identification and may include, but not be limited to, elements such as title, abstract, author, and keywords. Structural metadata relates to containers of data and indicates how compound objects are assembled and may include, but not be limited to, how pages are ordered to form chapters, and typically describes the types, versions, relationships, and other characteristics of digital materials. Administrative metadata may provide information employed in managing a resource and may include, but not be limited to, when and how it was created, file type, technical information, and who can access it. Reference metadata may describe the contents and quality of statistical data whereas statistical metadata may also describe processes that collect, process, or produce statistical data. Statistical metadata may also be referred to as process data.

An “artificial intelligence system” (referred to hereafter as artificial intelligence, AI) as used herein, and throughout disclosure, refers to machine intelligence or machine learning in contrast to natural intelligence. An AI may refer to analytical, human inspired, or humanized artificial intelligence. An AI may refer to the use of one or more machine learning algorithms and/or processes. An AI may employ one or more of an artificial network, decision trees, support vector machines, Bayesian networks, and genetic algorithms. An AI may employ a training model or federated learning.

“Machine Learning” (ML) or more specifically machine learning processes as used herein refers to, but is not limited, to programs, algorithms, or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an AI may include, but not be limited to, supervised learning, unsupervised learning, cluster analysis, reinforcement learning, feature learning, sparse dictionary learning, anomaly detection, association rule learning, inductive logic programming.

A “road” or “lane” or “roadway” as used herein may refer to, but is not limited to, a path or flight path or a surface for the conveyance of one or more types of vehicle or a path/route for the conveyance of one or more types of vehicle. A road may have an improved surface for use by the one or more types of vehicles (e.g., motorized, and non-motorized). A road may include, but not be limited to, parkways, avenues, controlled-access highways, freeways, motorways, expressways, tollways, interstates, highways, thoroughfares, and local roads. It may have one or more lanes, support unidirectional traffic flow, bidirectional traffic flow, support a single type of traffic (e.g., a cycle path), or support multiple types of traffic (e.g., shared-used paths or roads) for example. A road may comprise one or more other features including, but not limited to, sidewalks (pavement), medians, shoulders, and verges.

A “vehicle” as used herein may refer to, but is not limited to, a machine that transports one or more individuals, cargo etc. A vehicle may include, but not be limited to, a wagons, a bicycles, a motor vehicle (e.g., a motorcycle, a car, a truck, a bus etc.), a railed vehicle (e.g., a train or a tram), watercraft (e.g., a ship, a boat or an underwater vehicle), an amphibious vehicle (e.g., a screw-propelled vehicle or a hovercraft), or an aircraft (e.g. an airplane, a helicopter, or an aerostat).

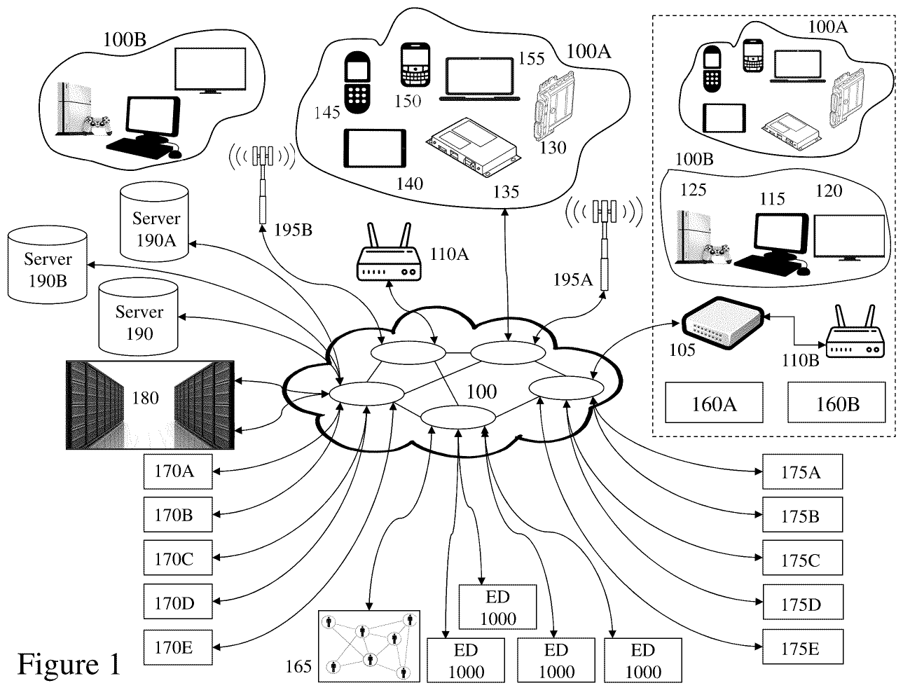

Referring to FIG. 1 there is depicted a Network 100 within which embodiments of the invention may be employed supporting Semi-Autonomous and Autonomous Vehicle (SAAV) Systems, Applications and Platforms (SAAV-SAPs) according to embodiments of the invention. Such SAAV-SAPs, for example, supporting multiple communication channels, dynamic filtering, etc. As shown first and second SAAV groups 100A and 100B respectively interface to a telecommunications Network 100. Within the representative telecommunication architecture, a remote central exchange 180 communicates with the remainder of a telecommunication service providers network via the Network 100 which may include for example long-haul OC-48/OC-192 backbone elements, an OC-48 wide area network (WAN), a Passive Optical Network, and a Wireless Link. The central exchange 180 is connected via the Network 100 to local, regional, and international exchanges (not shown for clarity) and therein through Network 100 to first and second cellular APs 195A and 195B respectively which provide Wi-Fi cells for first and second SAAV groups 100A and 100B, respectively. Also connected to the Network 100 are first and second Wi-Fi nodes 110A and 110B, the latter of which being coupled to Network 100 via router 105. Second Wi-Fi node 110B is associated with commercial service provider 160, e.g., Gillette Stadium™, comprising other first and second SAAV groups 100A and 100B. Second SAAV group 100B may also be connected to the Network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of SAAV users 100A may employ a variety of portable electronic devices (PEDs) including for example, laptop computer 155, radio control unit (RCU) 135, tablet computer 140, smartphone 150, cellular telephone 145, and engine control unit (ECU) 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second SAAV groups 100A and 100B. Alternatively the first and second SAAV groups 100A and 100B may be geographically disparate and access the Network 100 through multiple APs, not shown for clarity, distributed geographically by the network operator or operators. First cellular AP 195A as show provides coverage to first SAAV group 100A and environment 170, which comprises second SAAV group 100B as well as first SAAV group 100A. Accordingly, the first and second SAAV groups 100A and 100B may according to their particular communications interfaces communicate to the Network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first SAAV group 100A may form associations either through standards such as IEEE 802.15 or Bluetooth as well in an ad-hoc manner.

Also connected to the Network 100 are Social Networks (SOCNETS) 165, first and second service providers 170A and 170B respectively, first and second third party service providers 170C and 170D respectively, and a user 170E. Also connected to the Network 100 are first and second enterprises 175A and 175B respectively, first and second organizations 175C and 175D respectively, and a government entity 175E. Also depicted are first and second servers 190A and 190B may host according to embodiments of the inventions multiple services associated with a provider of contact management systems and contact management applications/platforms (SAAV-SAPs); a provider of a SOCNET or Social Media (SOME) exploiting SAAV-SAP features; a provider of a SOCNET and/or SOME not exploiting SAAV-SAP features; a provider of services to PEDS and/or FEDS; a provider of one or more aspects of wired and/or wireless communications; an Enterprise 160 such as a vehicle manufacturer exploiting SAAV-SAP features; license databases; content databases; image databases; content libraries; customer databases; websites; and software applications for download to or access by FEDs and/or PEDs exploiting and/or hosting SAAV-SAP features. First and second primary content servers 190A and 190B may also host for example other Internet services such as a search engine, financial services, third party applications and other Internet based services.

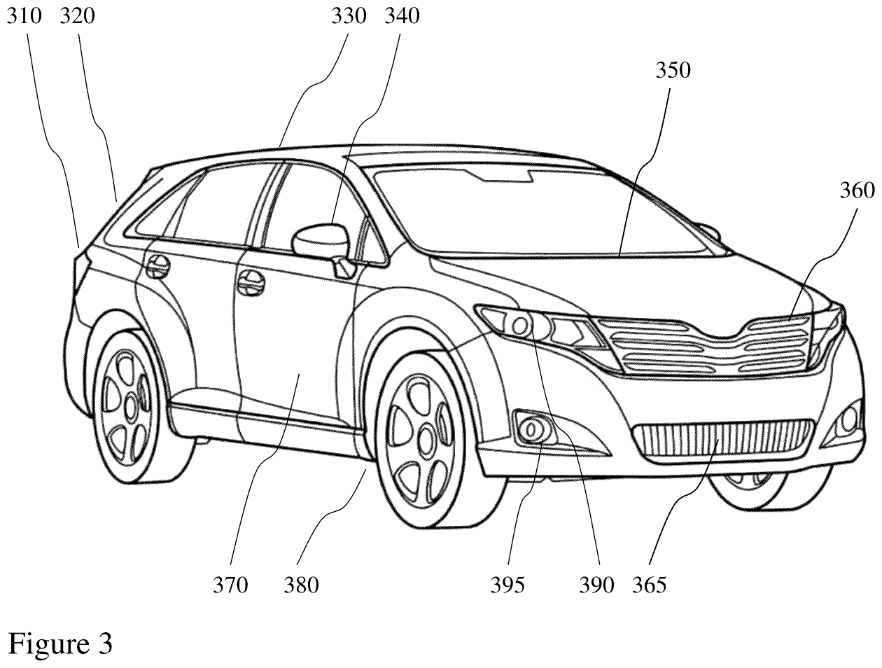

Also depicted in FIG. 1 are Electronic Devices (EDs) 100 according to embodiments of the invention such as described and depicted below in respect of FIGS. 3 to XXX. As depicted in FIG. 1 the EDs 100 communicate directly to the Network 100. The EDs 100 may communicate to the Network 100 through one or more wireless or wired interfaces included those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, a user and/or vehicle may exploit a PED and/or FED within an Enterprise 160, for example, and access one of the first or second primary content servers 190A and 190B respectively to perform an operation such as accessing/downloading an application which provides SAAV-SAP features according to embodiments of the invention; execute an application already installed providing SAAV-SAP features; execute a web based application providing SAAV-SAP features; or access content. Similarly, a CONCUS may undertake such actions or others exploiting embodiments of the invention exploiting a PED or FED within first and second SAAV groups 100A and 100B respectively via one of first and second cellular APs 195A and 195B respectively and first Wi-Fi nodes 110A. It would also be evident that a CONCUS may, via exploiting Network 100 communicate via telephone, fax, email, SMS, social media, etc.

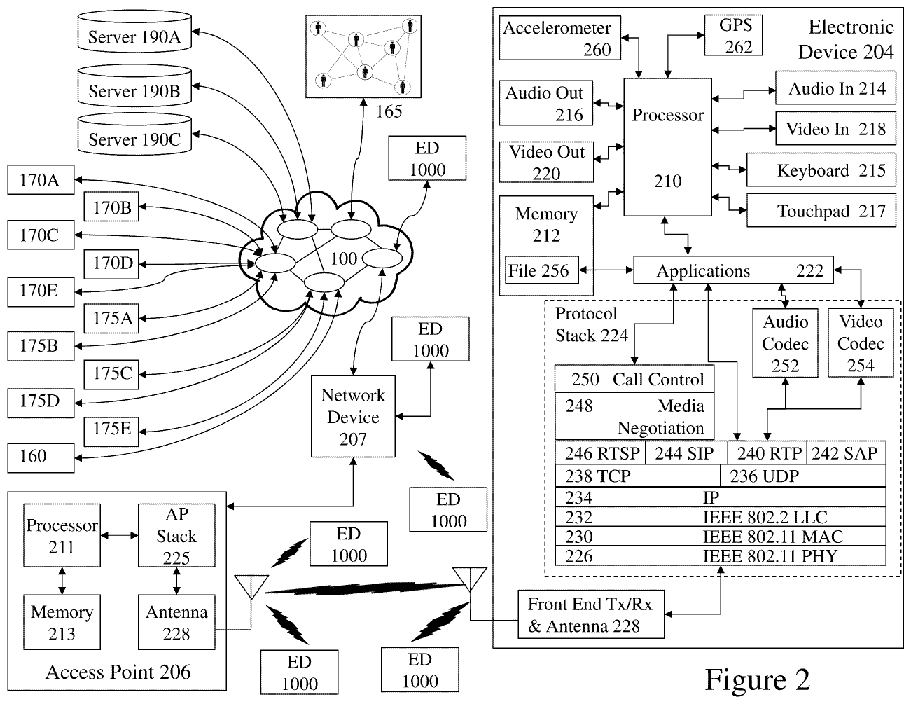

Now referring to FIG. 2 there is depicted an Electronic Device 204 and network access point 207 supporting SAAV-SAP features according to embodiments of the invention. Electronic Device 204 may, for example, be a PED and/or FED and may include additional elements beyond those described and depicted. Also depicted within the Electronic Device 204 is the protocol architecture as part of a simplified functional diagram of a system 200 that includes an Electronic Device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to Network 100 and therein Social Networks (SOCNETS) 165, first and second service providers 170A and 170B respectively, first and second third party service providers 170C and 170D respectively, a user 170E, first and second enterprises 175A and 175B respectively, first and second organizations 175C and 175D respectively, and a government entity 175E.

The Electronic Device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an audio output element 216, for example, a speaker, coupled to any of processors 210. Electronic Device 204 may include a video input element 218, for example, a video camera or camera, and a video output element 220, for example an LCD display, coupled to any of processors 210. Electronic Device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Electronic Device 204. The one or more applications 222 that are typically stored in memory 212 and are executable by any combination of processors 210. Electronic Device 204 also includes accelerometer 260 providing three-dimensional motion input to the process 210 and GPS 262 which provides geographical location information to processor 210.

Electronic Device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the Electronic Device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by Electronic Device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted in FIG. 2 are Electronic Devices (EDs) 100 according to embodiments of the invention such as described and depicted below in respect of FIGS. 3 to XXX. As depicted in FIG. 2 an EDs 100 may communicate directly to the Network 100. Other EDs 100 may communicate to the Network Device 207, Access Point 206, and Electronic Device 204. Some EDs 100 may communicate to other EDs 100 directly. Within FIG. 2 the EDs 100 coupled to the Network 100 and Network Device 207 communicate via wired interfaces. The EDs 100 coupled to the Access Point 206 and Electronic Device 204 communicate via wireless interfaces. Each ED 100 may communicate to another electronic device, e.g., Access Point 206, Electronic Device 204 and Network Device 207, or a network, e.g., Network 100. Each ED 100 may support one or more wireless or wired interfaces including those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED such as a RCU 135 or ECU 130 for example, wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the Network 100 using the electronic device or within either the access point 206 or network device 207 wherein details of the transaction are then coupled to the Network 100 and stored within remote servers.

Optionally, rather than wired and./or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH) etc.

Within the following description embodiments of the invention are described and depicted with respect to a car. However, it would be evident that the embodiments of the invention may be employed with other vehicles without departing from the scope of the invention.

Within the following description embodiments of the invention are described and depicted with respect to semi-autonomous and autonomous vehicles they may also be employed with non-autonomous vehicles without departing from the scope of the invention.

Within the following description embodiments of the invention are described and depicted with respect to vehicles being upon a roadway, lane, or road. However, it would be evident that the embodiments of the invention may be applied to any surface upon which a vehicle is traversing or intends to traverse.

### Electrical Generation

Internal combustion engines (ICEs) employ a radiator to help eliminate excess heat from the ICE. It forms part of the engine's cooling system, which also includes a liquid coolant, hoses to circulate the coolant, a fan, and a thermostat that monitors the coolant temperature. This radiator is disposed behind a grille that allows air to flow through the grill and over the radiator. However, as electric vehicles do not require a radiator for cooling most manufacturers have removed them such that the front of the vehicle is a solid panel or a series of patterned panels for visual aesthetics only.

Within prior art ICE vehicles electrical power to top up the standard 12V rechargeable lead acid battery is established from an alternator which generates electrical power when the ICE is running. Accordingly, it would be beneficial to generate electrical power for non-ICE vehicles such as electric vehicles. This generated electrical power is either provided to either a first battery system for the electric motor(s) of the vehicle or to a second battery system dedicated to powering the electrical control systems for the vehicles such as DAS, ADAS, etc. A second battery system independent of the first battery system would allow for the electrical control system(s) of the vehicle to maintain full or partial functionality in the event of a failure of the first battery system or the first battery system has dropped below a predetermined charge threshold. For example, the electrical control system(s) may apply brake(s) and/or navigate the vehicle to a parking spot or stopping location out of a traffic lane it is currently in such that the stopped vehicle in not blocking traffic or abruptly stops causing an accident. It would also be evident to one of skill in the art that a second battery system may also keep the onboard electronic systems active and running in order to maintain some or all functions of the vehicle apart from motive power. Optionally, the second battery system when enabled will cause the onboard electronic systems to enter one failure mode of a plurality of failure modes each of which supports different subsets of functionality of the vehicle.

Within embodiments of the invention the charging of the second battery system may be linked to charging of the first battery system when the vehicle is being charged from an external source or it may be linked to a separate charging system. Similarly, during kinetic motion or in energy recovery modes such as braking the charging of the second battery system may be linked to charging of the first battery system or it may be separate. For example, a separate charging during motion of the second battery system from a different generator within the vehicle would allow for decoupling of the second battery charging from the first battery charging such that heavy drains on the first battery charge and hence recharging do not result in depletion of the second battery system to a level it cannot function for a minimum period of time after depletion or failure of the first battery system so that the second battery system can enact the appropriate failure mode of the available failure modes to reduce the likelihood of collision, damage, congestion etc.

Within an embodiment of the invention a sub-system of the electrical control system may be provided with electrical power independently from the first battery system and/or second battery system. Optionally, each sub-system of a set of sub-systems of the electrical control system may be provided with electrical power independently from each other and/or the first battery system and/or second battery system. A sub-system of the electrical control system or the set of sub-systems of the electrical control system may comprise a battery and/or controller together with an actuator(s) and/or sensor(s) and/or indicator(s). For example, a controller may be associated with visual indicator(s) of the vehicle (e.g., brake light(s) or indicator light(s)) wherein the controller upon determining a failure of communications from the engine control unit triggers a predetermined action, e.g., placing the brake light(s) or indicator light(s) into a predetermined pattern (e.g. flashing at predetermined rate, flashing in a defined sequence other than simple on-off cycle, etc.). Alternatively, the controller may gradually apply a brake to slow vehicle whilst triggering the brake light(s) or indicator light(s) into a predetermined pattern. Such actions may also be established in dependence upon determining that the first battery system has dropped below a predetermined charge threshold.

Within embodiments of the invention the power generation may be generated from an air turbine which comprises an air collector portion, an air concentration portion, and a turbine for converting the air flow to rotary electrical power generator wherein the rotary electrical power generator comprises, for example, a dynamo which generates a pulsing direct current (DC) through the use of a commutator or an alternator generating an alternating current (AC) which is employed directly or subsequently converted to DC via an AC-DC converter.

For example, the air collector and/or air concentrator may be a vortex generator which generates a pattern of vortices which then cause a structure to oscillate that generates electrical power, e.g., using a linear alternator. For example, the air collector and/or air concentrator may employ a rotor exploiting a fixed or pivoting spiral to generate the air flow to the dynamo or alternator. For example, the air collector and/or air concentrator may employ a Venturi effect to accelerate air flow to generate a high velocity narrow air stream from a low velocity large area intake. Alternatively, multiple Venturi effect elements may form the air collector and/or air concentrator which are combined prior to the electrical generator. Alternatively, the air collector and/or air concentrator may employ multiple stages of blades to establish a high pressure compressor, a low pressure compressor or a dual stage system comprising low and high pressure compressors. Optionally, multiple air collectors and/or air concentrators may be coupled to a common rotary electrical power generator.

Within other embodiments of the invention the air collector may be an air deflector disposed upon another portion of the vehicle, such as a side, roof, or underside of the vehicle. For example, referring to FIG. 3 an air collector for a vehicle may be formed as part of a Rear Light Cluster 310, Rear Body Panel 320, Roof Panel 330, Mirror 340, Air Intake Vent 350 (e.g. as part of the air management system of the air for the passengers within the vehicle), Front Grille 360, Body Grille 365, Side Panel 370, Underside 380, Front Light Cluster 390, or a dedicated Air Collector 395.

Within some environments a rotary electrical power generator may be subject to freezing due to it being within an environment where freezing occurs. This freezing may be exacerbated by wind chill from the vehicle's motion. Accordingly, a rotary electrical power generator may incorporate one or more heating elements either to heat one or more elements of the rotary electrical power generator itself or to warm the air flow from the external environment. A rotary electrical power generator being an air turbine based electrical generator in some embodiments of the invention. The one or more heating elements may be enabled when a temperature, e.g., an ambient air temperature or ambient temperature adjusted for the vehicle's speed, drops below a predetermined threshold.

### Replenishing Station Location

Electric vehicles (EVs) represent one class of SAA Vs. For passenger vehicles the electrical battery capacity of an EV may range between approximately 18 kWh for the Smart EQ For Two, for example, up to 100 kWh for the Tesla Model S and Model X which can run for approximately 480 km (approximately 300 miles). Whilst these represent the full range of the vehicle before a full charge is required the vehicle may require intermediate recharging during use. However, it is necessary to guide autonomous and non-autonomous vehicles to mobile or stationary electrical charging stations (also referred to as replenishing stations) which may employ one or more power sources to generate the electricity, such as hydrocarbon, hydrogen, nuclear, battery etc., in addition to those connected to an electrical power grid.

Accordingly, there exists a requirement for using passive or active electronic elements and other elements to guide the vehicle to the charging station under all circumstances, such as under varying weather conditions or varying lighting etc.

However, semi-autonomous, autonomous, or non-autonomous vehicles require a navigation system to establish the replenishing station's location. This navigation system may, for example, be based on human knowledge or be pre-mapped through an application such as Google etc. However, human knowledge is useless when the user has never been to an area and applications such as Google require that the replenishing station's location be provided to the application and, if provided, it is accurate. Even in these scenarios the vehicle is only navigated to the location. There still exists the requirement for the vehicle to navigate to the specific charger that will recharge the vehicle either using a wired electrical connection or through a wireless electrical interface.

Optical systems, e.g., LIDAR-based (Light Detection and Ranging), or microwave/radar-based imaging systems may be employed for real-time mapping or pre-mapping the replenishing station's location but still require the vehicle is able to navigate and determine whether a charging station is free rather than occupied so that the vehicle can employ it. Pre-mapping is inefficient and, in most cases, impractical if there are continual changes as vehicles are in and out of the replenishing stations as the vehicles are in for replenishing and leave once it is done. Updating through a network to an application the latest updates or changes is time consuming, prone to network interruptions, etc. and still only provides the vehicle with a free station location but not how to navigate to the replenishing station. As with gasoline and diesel provisioning for ICEs it is also likely that replenishing stations will be provided by multiple enterprises with different designs, different layouts, capacities, capabilities etc. such that the processing of optical or microwave acquired data to define the replenishing station location and navigate the vehicle appropriately will require either a significant database and/or complex processing using artificial intelligence (AI) and/or machine learning (ML). Further, most “image” acquisition techniques suffer in terms of significant performance degradations or failures under inclement weather and/or certain luminous conditions.

Accordingly, it would be beneficial to provide SAAVs, or a DAS system for non-autonomous vehicles, with the ability to navigate to the replenishing station more effectively under normal or severe weather conditions and any illumination conditions. Further, in many instances replenishing stations may be dynamically located so that recharging at one-off events etc. can be provided or replenishing stations dynamically adapted to accommodate projected requirements at that replenishing station location. Accordingly, it would be advantageous for the solution to provide an economical and efficient way to implement a self-assisted navigation system.

Accordingly, a replenishing station may be a fixed or mobile replenishing station that can replenish automatically, semi-automatically, or manually. The replenishing station within embodiments of the invention may provide electrical recharging but it would be evident that within other embodiments of the invention the replenishing station may provide another fuel source to the vehicle, such as hydrogen, gasoline, or diesel for example to accommodate ICEs and hybrid ICE-electrical vehicles.

The replenishing station may generate electrical power locally, e.g., through solar, wind, water etc. or it may be a hydrogen fuel generator, a hydrogen storage tank, a gasoline storage tank, a diesel fuel tank, a battery set or any combination thereof. The replenishing station may be mobile, semi-portable or fixed. The replenishing station may replenish a single vehicle or multiple vehicles simultaneously, concurrently, periodically and/or continuously.

Within an embodiment of the invention a replenishing station upon installation at a location establishes it geolocation, e.g. using a global positioning system (GPS) or it may employ one or more triangulation techniques such as wireless, optical, microwave, radar etc. from a series of beacons with known locations in order to overcome the limitations of GPS in instances where there is not a clear line of sight to the sky, such as in cities, underneath bridges, inside tunnels, within parking structures, in wooded areas, in areas with valleys or mountains etc. As the typical accuracy of GPS is approximately 3 meters (approximately 10 feet) unless the replenishing stations are distributed at a larger separation the vehicle will not be able to accurately define one replenishing station from another yet alone one side of a replenishing station from the other side of the replenishing station.

Accordingly, whilst a navigation system may navigate the SAAV to the general vicinity of the replenishing station a secondary system will be required to direct the SAAV to the replenishing station and a specific point with respect to the replenishing station. For example, a system of sensor devices strategically placed on the SAAV may provide data to a Vehicle Control Unit (VCU) forming part of the SAAV wherein the VCU then processes this information which it then passed onto a navigation control system of the SAAV to navigate the SAAV. Optionally, the processed data from the VCU may be stored within a map navigation database system of the SAAV and/or pushed to a remote map navigation database system. The VCU may be part of the ECU of the vehicle, the ECU may form part of the VCU or the ECU is in communication with the VCU.

Within an embodiment of the invention the SAAV upon arrival at a replenishing station location broadcasts a first message indicating that SAAV's requirement for recharging. In one scenario this requirement is that required to recharge the SAAV from current capacity to full capacity. The replenishing station location upon receipt of the request identifies a specific replenishing station that can provide the requirement of the SAAV which is currently empty of a SAAV and advises the SAAV of the specific replenishing station. The replenishing station location then updates the status of the replenishing station so that it does not provide it to another vehicle until it has verified that the SAAV has recharged and departed.

Within embodiments of the invention a replenishing station of a set of replenishing stations may be assigned to the SAAV based upon the requirements of the SAAV in terms of charge required, SAAV recharging requirements (e.g., minimum voltage, minimum current, maximum voltage, maximum current, DC/AC/pulsed charging etc.). Such requirements may be established in dependence upon an aspect of the vehicle such as a unique serial number (e.g., the Vehicle Identification Number (VIN)), data provided by the SAAV to the replenishing station etc. Alternatively, the replenishing stations may transmit their availability and capabilities as well as unique data relating to location or transponder identities etc. whereby the SAAV selects the replenishing station to recharge at, reserves a replenishing slot and then navigates at the reserved time.

If, no empty replenishing station is able to provide the requirement the SAAV can be advised of this together with additional information in order for the SAAV to establish a replenishing station to employ. This additional information may be selected from capacities of current empty replenishing stations, projected time(s) to replenishing station(s) becoming free with the requested capacity, and identities of replenishing station(s) capable of providing sufficient capacity for the SAAV to navigate to another replenishing station location with the requested capacity or another replenishing station location. Accordingly, the VCU within the SAAV establishes which replenishing station it will employ, notifies the replenishing station location, and proceeds to move to the replenishing station. The VCU may communicate directly or via the replenishing station location to establish payment for the charging.

Optionally, if the replenishing station location is within a parking lot with associated parking charges, then the VCU may also establish appropriate parking fees to be paid for a projected time the SAAV will be in the parking lot at the replenishing station together with the charging fee(s) either as a rate or fixed fee for the recharge. A replenishing station may charge based upon a rate of energy quantity, e.g., a rate per kW, litre, etc., or based upon an agreed total energy to be provided by the replenishing station, e.g., based upon a negotiated or requested quantity of energy. These charge(s) may, for example, be collected via conventional payments systems like credit cards, debit cards or a pre-established account linked to the user of the SAAV or the SAAV. The pre-established account linked to the user of the SAAV or the SAAV being provided to the replenishing station for example by the user of the SAAV through an electronic device associated with the user or the SAAV or by the SAAV automatically based upon information associated with the SSAV, the trip of the SAAV etc.

Data transmitted to the SAAV of the specific replenishing station may comprise location information, marker data (see below) to navigate to the specific replenishing station, etc.

Within embodiments of the invention a physical link may be established between the vehicle and the replenishing station in addition to a non-mechanical link (e.g., optical, microwave, RF, magnetic, electromagnetic etc.) to provide a fail-safe such that in the event of the link, physical or non-physical, being broken or interrupted the replenishing station automatically stops replenishing. Whilst not a major issue with electromagnetic recharging of electrical vehicles autonomous re-fueling of gasoline, diesel, hydrogen based SAAVs etc., is a significant safety concern.

For example, an electromagnet may be selectively engaged and disengaged through application of a control electrical signal to the electromagnet. Accordingly, upon a vehicle being aligned correctly to the replenishing station the electromagnet provides a magnetic coupling from the vehicle to the replenishing station thereby closing a control circuit such that the replenishing station begins providing the refueling to the vehicle. If there is a failure in the vehicle's systems or it moves then the electromagnetic link is broken such that the control circuit within the replenishing station changes state and the refueling process stops. Accordingly, for example, an electromagnetic interface between the vehicle and replenishing station allows for refueling to begin only when the control circuit of the replenishing station is in the correct state but a failure or partial failure in the electromagnetic linkage results in the refueling being halted.

This electromagnetic element may be one of a series of safety connection protocols to ensure the connection is properly connected before replenishment begins, once the replenisher is securely connected between the vehicle and replenisher and any adjustments of the connection(s) are necessary and have passed all the safety checks before the replenisher can start replenishing the vehicle, even if electrical recharge, hydrocarbon refueling, or hydrogen for example. Within embodiments of the invention the electromagnetic interface may be part of a nozzle or connector between the replenishing station and the vehicle such that the electromagnetic connection is the last connection between the replenishing station and the vehicle to be made before refueling and the first connection to be broken. Such an electromagnetic mechanical safety system may be replaced with permanent magnet-based interfaces although these can be over-ridden unlike an electromagnetic interface requiring that the vehicle and replenishing station be in communication with the appropriate verifications, hand-offs etc. before the electromagnet(s) are activated. Optionally, electromagnets may be required to be engaged upon both the replenishing station and the vehicle.

Whilst within the embodiments of the invention described above the electromagnetic connection/switch-based safety system have been described with respect to a nozzle or connector between the replenishing station and the vehicle it would be evident that within other embodiments of the invention the electromagnetic safety system may be discrete from any nozzle or connector between the replenishing station and the vehicle providing the re-fueling. For example, the electromagnetic coupling may be provided between the replenishing station and the vehicle with the vehicle portion being upon part of the side, roof, or underside of the vehicle. For example, an electromagnetic interface may form, as depicted in FIG. 3, as part of a Rear Light Cluster 310, Rear Body Panel 320, Roof Panel 330, Mirror 340, Front Grille 360, Body Grille 365, Side Panel 370, Underside 380, Front Light Cluster 390 as well as front bumper, rear bumper, side bumper etc. Optionally, the electromagnetic coupling between the replenishing station and the vehicle may be fixed in position upon the replenishing station and/or the vehicle or a portion associated with one of the replenishing station and the vehicle may be adjustable in position such that it moves from a stored position to a deployed position upon a control signal to it from the replenishing station and/or the vehicle.

### Marker Based Positioning/Guidance of Vehicle

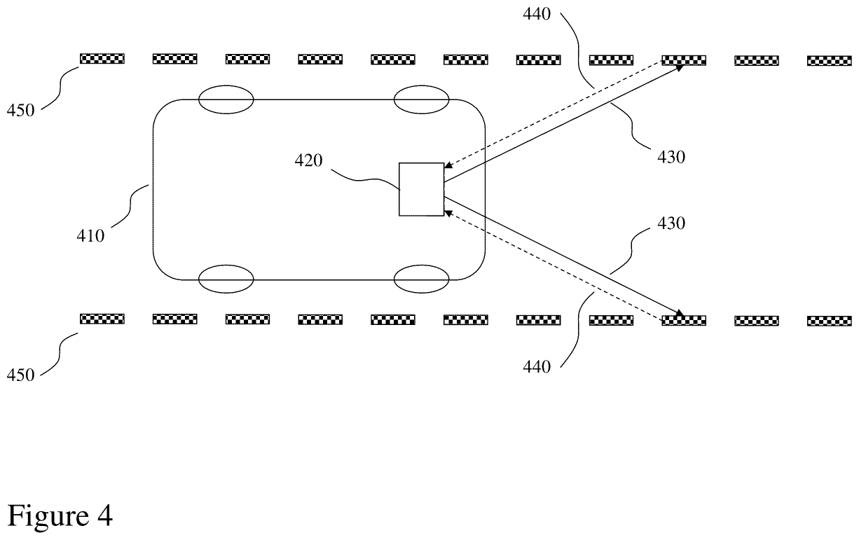

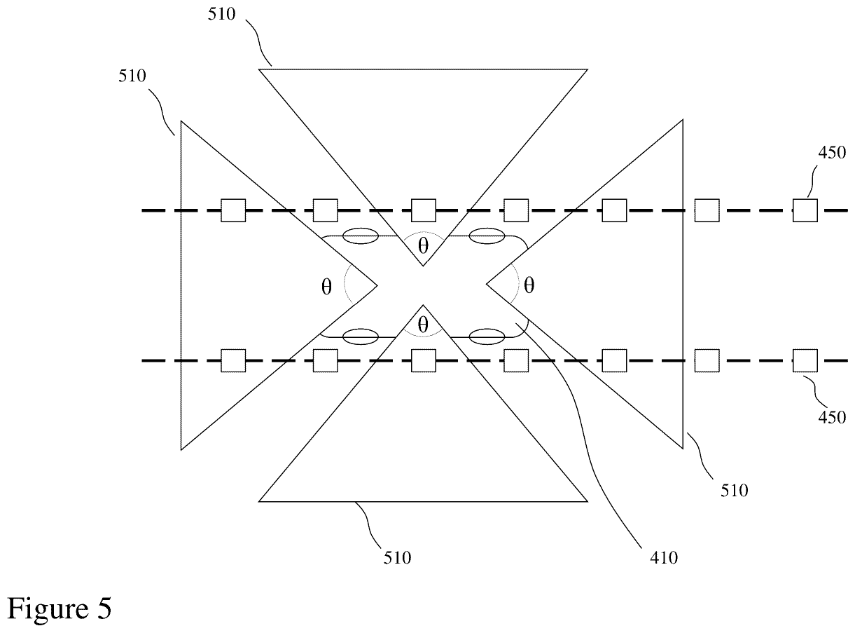

Once the appropriate information has been gathered by the SAAV, the VCU, once the information has been processed, it is then communicated back to the autonomous control system and/or 3D map navigation database system of the SAAV. The navigation of the SAAV may be through two or more steps, e.g., a first step may be based upon a navigation system the SAAV employed to reach the replenishing station location, and then a second step based upon a secondary navigation system of the SAAV designed to navigate the SAAV with an accuracy superior to that of the system employed in the first step. For example, the secondary navigation system may employ markers deployed at the replenishing station location as described and depicted with respect to FIGS. 4 and 5.

Referring to FIG. 4 there are depicted a plurality of Markers 450 disposed in a predetermined pattern, in this instance two parallel sets of Markers 450 to define a lane within which Vehicle 410 is to navigate wherein the Vehicle 410 establishes the location of the Markers 450 from one or more Transceivers 420. Within an embodiment of the invention the Markers 450 may be, for example, one or more of:
a paint based marker with one or more metallic elements for reflecting microwave or RF signals emitted from the Transceiver 420;
a metallic paint for reflecting microwave or RF signals emitted from the Transceiver 420;
an optical emitter which lights up in response from a signal from the Transceiver 420 wherein the Transceiver 420 then optically captures the location of the Marker(s) 450 where the optical emitter may be ultraviolet, infrared, visible or a combination thereof;
an optical emitter which lights up in response to detecting the Vehicle 410, e.g., motion-based sensing (e.g., radar/lidar) or headlight detection for example, wherein the Transceiver 420 then optically captures the location of the Marker(s) 450 where the optical emitter may be ultraviolet, infrared, visible or a combination thereof;
a microwave emitter which emits a microwave or RF signal in response to a received microwave or RF signal from the Transceiver 420;
a reflective microwave circuit which emits a microwave or RF signal generated by receiving and processing a microwave or RF signal from the Transceiver 420; or
an optical reflective marker which receives an optical signal from the Transceiver 420 and reflects a predetermined portion of the optical signal where the optical signal may be ultraviolet, infrared, visible or a combination thereof.

Where the Marker 450 is an optical emitter or microwave emitter then the Markers 450 may be powered from the replenishing station or replenishing station location or they may employ a battery, solar etc. A reflective microwave circuit may be similar to a RFID circuit for example. Markers may within embodiments of the invention be solar powered or battery powered with solar recharging.

An optical reflective marker may reflect one predetermined portion of the optical signals to Vehicles 410 travelling in one direction relative to the optically reflective marker and another predetermined portion of the optical signals to Vehicles 410 travelling in another direction relative to the optically reflective marker. In this manner, the Vehicle 410 can rapidly distinguish between markers for lanes within which the Vehicle 410 can travel to those for lanes the Vehicle 410 cannot travel within. For example, on a two-lane roadway with traffic limited to flowing in one lane in each direction the Vehicle 410 can rapidly filter markers for the lane it should navigate within from those it should not. Optionally, different markers for different lanes can reflect different portions and the Vehicle 410 can be advised which portions reflected relate to lanes it can access.

Where the Marker 450 is an optical emitter or microwave emitter then the Markers 450 may establish an emission pattern defined by the replenishing station or replenishing station location or predefined which is communicated to the SAAV such that it can isolate the Markers 450 for the replenishing station it is to navigate to from all those associated with other replenishing stations at the replenishing station location. Similarly, the reflective microwave circuits for a replenishing station may generate a different signal to those on an adjacent replenishing station.

As depicted in FIG. 4 an RF Signal 430 is generated from the Transceiver 420 forming part of the Vehicle 410, in incident upon the Markers 450 and is reflected as Reflected RF Signal 440. The Transceiver 420 may be a discrete self-contained unit or it may be multiple units etc. Based upon the timing information and/or incident angle of the Reflected RF Signals 440 from the Markers 450 the distance between the Vehicle 410 and the Markers 450 can be calculated. Where the Reflected RF Signals 440 contain data relating to the replenishing station, they are associated with an initial pre-processing may filter out those Reflected RF Signals 440 received from Markers 450 which are not associated with the replenishing station the Vehicle 410 is to align with. Optionally, the replenishing station may also contain one or more sensors that trigger the VCU within the Vehicle 410 to apply the brakes when the Vehicle 410 has aligned itself with the replenishing station.

It would be evident that, as depicted in FIG. 5, multiple beams from multiple Transceivers 420, not depicted for clarity, may be employed to provide data from the front, back, and sides of the Vehicle 410. As depicted the coverage of each transmitted Beam 510 from the Vehicle 410 is θ. However, the Beam 510 for the front, back and sides may have different angular spreads. Further, multiple Transceivers 420 may be deployed on the front, back or sides with common angular spreads or different angular spreads. Within embodiments of the invention the Transceivers 420 employed for aligning the Vehicle 420 to a replenishing station may have different emission characteristics such as power, frequency, pulse repetition rate, angular spread etc. than other Transceivers 420 employed for navigating the Vehicle 410 upon a road.

Optionally, the Transceivers 420 may be configurable according to the current state of the Vehicle 420. For example, the Transceiver(s) 420 upon the rear of the Vehicle 410 may only be activated when the Vehicle 410 is reversing or about to reverse. Alternatively, the Transceiver(s) 420 may be dynamically configurable upon a state of the Vehicle 410 such that, for example, the emission characteristics such as power, frequency, pulse repetition rate, angular spread etc. are varied according to one or more aspects of the Vehicle 410 such as speed, mode, or direction for example. For example, in a driving mode along a road the Markers 450 are those ahead of the Vehicle 410 to define the lane and direction ahead of the vehicle to allow the VCU to adjust the Vehicle 410 trajectory along the lane but in a parking mode the Markers 450 are those close to the Vehicle 410 and accordingly the angular spread may be down closer to the Vehicle 410 rather than further away from the Vehicle 410. Alternatively, the Transceiver 420 may be upon a Configurable Mount that allows the Transceiver 420 to be directed according to the mode of the Vehicle 410.

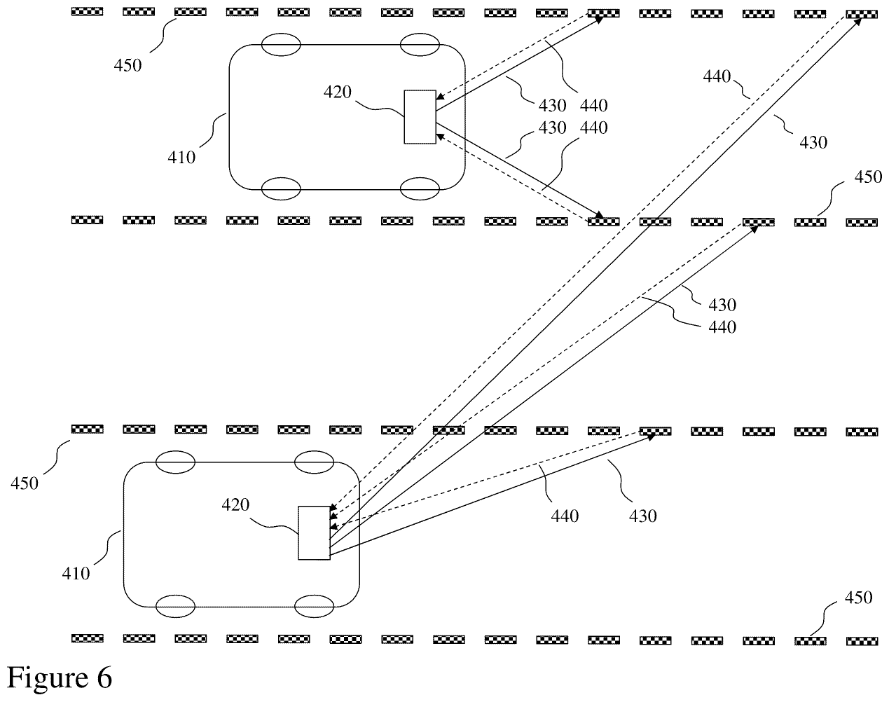

Referring to FIG. 6 the schematic depicts how the Transceiver 420 can detect the Markers 450 immediately adjacent to the Vehicle 410 but also the Markers 450 that are one or multiple lane(s) over from the current lane that the vehicle is on. For ease of representation in FIG. 6 an upper Vehicle 410 shows the RF Signals 430 and Reflected RF Signals 440 in the current lane the Vehicle 410 is on whilst a lower Vehicle 410 shows the RF Signals 430 and Reflected RF Signals 440 in the adjacent lanes to one the Vehicle 410 is on. This being easier to depict the multiple RF Signals 430 and Reflected RF Signals 440 from the Vehicle 410.

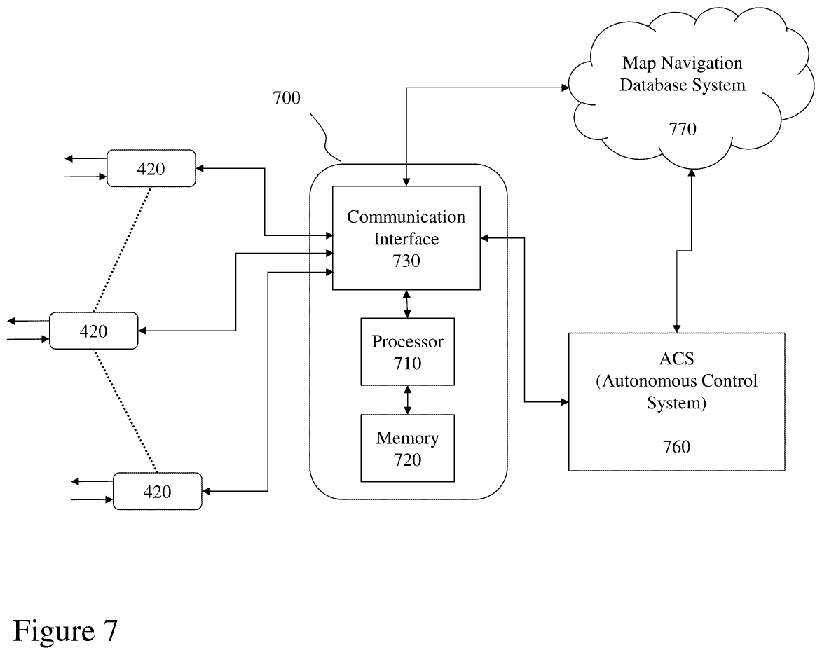

Referring to FIG. 7 there is depicted a schematic of the VCU 700 which comprises a Communications Interface 730, a Processor 710, and a Memory 720. The Communications Interface 730 is coupled to Transceivers 420, an Autonomous Control System 760, and a Map Navigation Database System 770. The Autonomous Control System 760 is also coupled to the Map Navigation Database System 770.

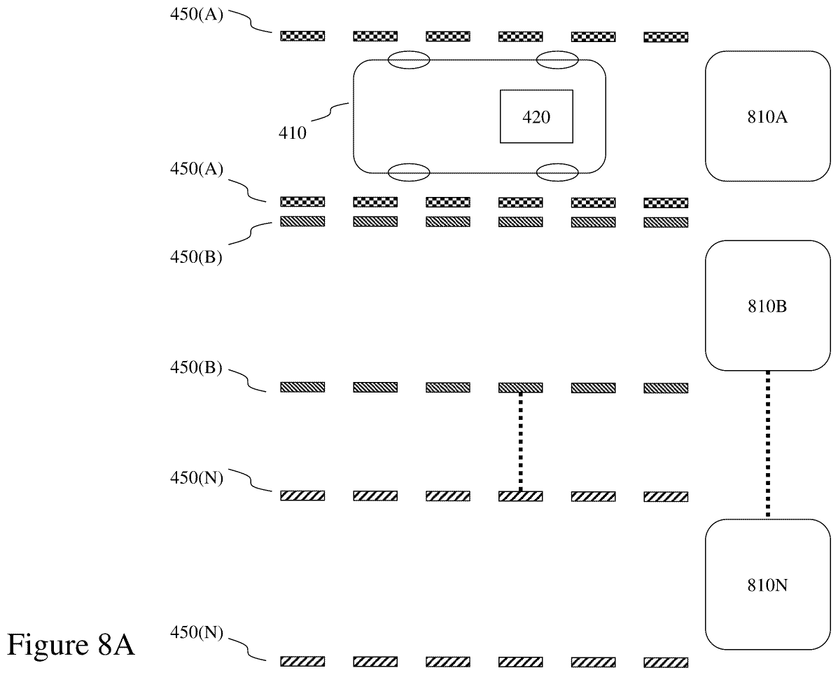

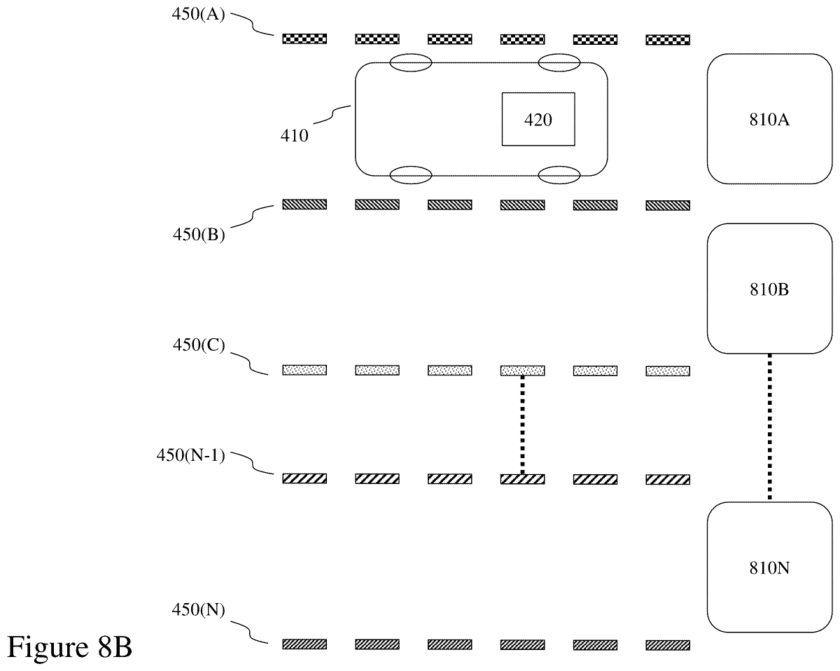

Within an embodiment of the invention the replenishing station location may support provisioning of multiple fuel types and/or multiple replenishing stations as depicted in FIG. 8A. As depicted a plurality of Replenishing Stations 810A, 810B to 810N are at a replenishing station location. Associated with first Replenishing Station 810A are first Markers 450A allowing the Vehicle 410 to navigate to the first Replenishing Station 810A from signals acquired by the Transceiver 420. Second Replenishing Station 810B is associated with second Markers 450B and the Nth Replenishing Station 810N is associated with Nth Markers 450N.

In contrast in FIG. 8B:
to use the first Replenishing Station 810A the Vehicle 410 would acquire signals from first Markers 450A and second Markers 450B;
to use the second Replenishing Station 810B the Vehicle 410 would acquire signals from second Markers 450B and third Markers 450C; and
to use the Nth Replenishing Station 810N the Vehicle 410 would acquire signals from (N-1)th Markers 450(N-1) and Nth Markers 450(N).

Within an embodiment of the invention then referring to FIGS. 8A and 8B the fuel types for vehicles for the plurality of Replenishing Stations 810A, 810B to 810N may be the same whilst within another embodiment of the invention the fuel types for vehicles the plurality of Replenishing Stations 810A, 810B to 810N may be associated with two or more fuel types.

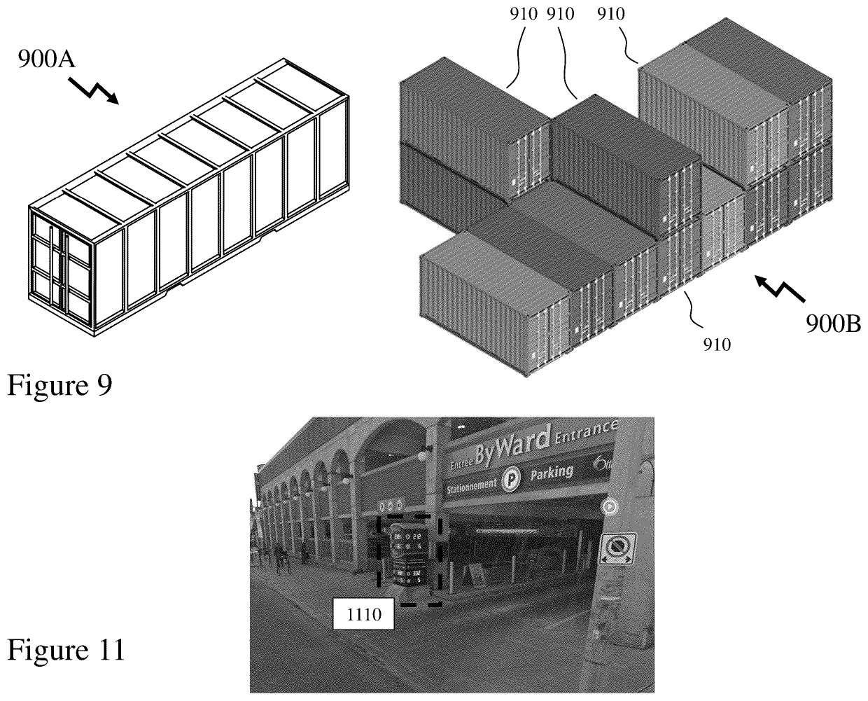

Referring to FIG. 9 there is depicted a first Replenishing Station 900A based upon a container whilst second Replenishing Station 900B employs a plurality of Containers 910 which can be stacked or placed side-by-side, end-on-end etc. so that the side, rear, bottom surfaces of upper Containers 910 may provide additional fuel, e.g. gasoline, diesel, or electrical power, to the lower or adjacent Containers 910 within the second Replenishing Station 900B. Connections between Containers 910 within second Replenishing Station 900B are through connections which may be automatically made when the Containers 910 are placed adjacent to each other etc. or are manually/robotically established. Containers 910 within a second Replenishing Station 900B may be swapped in or out of a configuration either in real time, based upon a predetermined schedule, or ad-hoc basis based upon usage etc. A Container 910 may, for example, comprise batteries, a hydrogen generator and/or hydrogen storage tank, a nuclear generator, gasoline storage, or diesel storage for example. Optionally, the Container 910 may support the deployment of solar panels, a wind turbine, or a water turbine such that it can provide extended replenishment to vehicles over a period of time.

The Container 910 may further comprise electronics such as described with respect to Electronic Device 204 in FIG. 2 to provide data to remote servers such as mapping location, wireless communications, GPS etc. Optionally, the Container 910 may provide a complete self-contained portable replenishing station wherein a strip, a mat of markers, strips of markers, e.g. Markers 450, are deployed from the container such that the markers are in defined positions relative to the Container 910 allowing a vehicle, for example a SAAV or Vehicle 410 in FIG. 4, to maneuver into the correct position such that the vehicle can replenish.

For example, the strip of markers, a mat of markers, strips of markers may slide out from the Container 910 or be an end panel/side panel of the Container 910 that hinges down when the Container 910 is positioned. The end panel and/or side panel may provide a support for the vehicle upon soft terrain as well as providing physical positioning of the markers relative to the Container 910. Within other embodiments the deployable end panel and/or side panel may include a wireless charger for an electric or hybrid vehicle such that contactless recharging can be provided wherein the electric or hybrid vehicle maneuvers according to the markers such that it is in the correct position for contact recharging. Optionally, a control system of the electric or hybrid vehicle may adjust the position of the vehicle in dependence upon one or more measurements relating to the charging in order to increase the rate of charging.

Optionally, a replenishing station may vary the total charge available per vehicle according to one or more factors including, but not limited to, location, date, time of day, weather conditions, projected weather conditions such that, for example, a replenishing station in a residential neighborhood, shopping center, office complex, etc. may, at projected busy times, increase the number of vehicles charged per hour. In contrast, at other times the same replenishing station may allow longer charges or a replenishing station at a highway rest area or service station may limit maximum charge at times when busy to that sufficient to take the vehicle to the next replenishing station on that highway. Alternatively, a projection of rain or detection of rain by the replenishing station may reduce charging times as more vehicles are expected to be on the roads than if the weather as dry.

The electronics of Container 910 may obtain data from, provide data to, or negotiate with a vehicle. Such information may include, for example, charging rate, hydrogen capacity, hydrocarbon grade, etc. The electronics of Container 910 may also obtain from a user of the vehicle account information relating to a financial transaction for the replenishing process or it may automatically obtain this based upon a unique identity of the vehicle which may, for example, be a digital vehicle identification number (VIN) provided from the VCU or ECU for example, a digital identity acquired from optically acquiring and processing a barcode (e.g. a one-dimensional barcode or two-dimensional barcode) at a predetermined location on the vehicle. Alternatively, the unique identity of the vehicle may be a digital license that is issued by one or more government authorities or it may be a digital license issued by an enterprise, service provider, consortium or manufacturer of the vehicle, This digital license can be transmitted from Vehicle to Infrastructure (V2I) or Vehicle to Vehicle (V2V) by optical or wireless communications or be acquired from optical processing of a license plate etc.

### Semi-Autonomous or Autonomous Vehicle Navigation in Complex Highways, Bridges, Blind Areas, or Unknown Areas

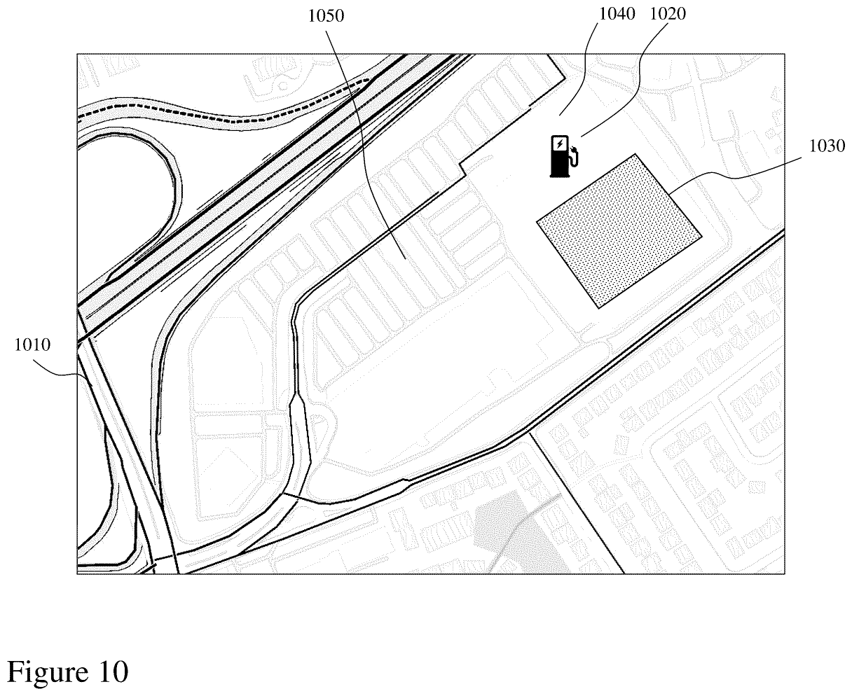

Within the prior art navigation of vehicles is based upon establishing a known location of a vehicle, orientating the vehicle to a roadway, and providing appropriate directions to the driver to navigate. The known location is typically obtained from GPS and orientating the vehicle to a roadway achieved by correlating the establish location to a map of a roadway or area. However, for semi-autonomous or autonomous vehicles this process would be automated without any human interaction to the actual navigation of the vehicle which would work under many scenarios but does not work where the area/roadway has not been uploaded to a map database accessible to the vehicle, e.g., in a new sub-division, off-road areas, remote areas, etc. This does not work either where the vehicle is in a location where GPS and/or cellular wireless based location determination is unobtainable or not possible such as within a tunnel, underground parking area, within a parking structure, etc. This does not work either where the vehicle is within a location where GPS based location is obtainable but the mapping database simply identifies the location with a generic block. For example, referring to FIG. 10 there is depicted a satellite image of the Pinecrest Mall, Ottawa, Canada associated with a store IKEA 1030 which has an Outdoor Parking Lot and an Indoor Parking Lot 1040. Within the Indoor Parking Lot 1040 is a Charging Station 1020 for electric vehicles.

Also depicted in FIG. 10 are Road Markers 1010 defined by Google™. Accordingly, it is evident that Google™ does not define the Outdoor Parking Lot 1050 in any more detail than two lines through it. Accordingly, a navigation system would not be able to direct a vehicle into a parking space within the Outdoor Parking Lot 1050 nor navigate the vehicle into the Indoor Parking Lot 1040 for parking or to access the Charging Station 1020.

According to an embodiment of the invention a vehicle, for example Vehicle 410 in FIG. 4, is equipped with one or more devices, e.g. transponders or transceivers, which can interact with and/or detect one or more active devices (ACTDEVs) associated with an area within which a navigation system employing the prior art technique based upon GPS etc. cannot provide any information or sufficient information for the navigation system to maneuver the vehicle.

Within embodiments of the invention an ACTDEV may be self-powered by solar and/or batteries or it may be connected to an electrical mains supply. Optionally, the ACTDEV identifies an approaching vehicle and downloads to it a specific navigation file associated with the location the ACTDEV provides information on. For example, referring to FIG. 11 the ACTDEV is associated with the Sign 1110 at the entrance to a parking structure. Alternatively, it may be associated with an automatic barrier for entry into the parking structure wherein the ACTDEV is triggered to initiate a broadcast of the navigation information upon the vehicle seeking access to the parking structure, e.g., passing a sensor.

The navigation information may comprise, for example, navigation directions to a predetermined parking spot within the parking structure (for example) where the parking spot has been determined as available and accommodating the vehicle. For example, as the vehicle approaches the parking structure it transmits information relating to it such as size such that the ACTDEV or a system in communication with the ACTDEV determines an available parking spot for the vehicle and navigation directions to the available parking spot. The ACTDEV may also communicate additional navigation directions for the vehicle to navigate away from the parking spot to an exit of the parking structure. Within the example of the Indoor Parking Lot 1040 in FIG. 10 the vehicle may have indicated that it is not seeking a parking spot but to replenish wherein the ACTDEV transmits navigation directions to the Charging Station 1020 from an entrance of the Indoor Parking Lot 1040 as well as subsequent directions to an exit of the Indoor Parking Lot 1040. Alternatively, the ACTDEV may establish through communications to the vehicle that it requires both a parking spot and to use the Charging Station 1020. Accordingly, the ACTDEV may provide navigation directions to the Charging Station 1020, then to a parking spot and thereafter for the vehicle to exit the Indoor Parking Lot 1040. Alternatively, the ACTDEV may establish navigation directions to the parking spot as the Charging Station 1020 is fully occupied as well as navigation directions from the parking spot to the Charging Station 1020, back to the same or another parking spot and thereafter to an exit of the Indoor Parking Lot 1040. The information provided to the vehicle may include timing data for when the vehicle should execute the navigation directions from the parking spot to the Charging Station 1020 and thereafter back to the same or another parking spot. In this manner the vehicle can be parked and replenished on schedule established by the ACTDEV in association with information from the Charging Station 1020.

Upon an exit of a parking structure an ACTDEV associated with the parking structure acquires information which has either been stored by one or more ACTDEVs during the vehicle's presence within the parking structure or by the vehicle. This acquired information may be employed to provide analysis of vehicle activities within the parking structure to allow for adjustments in one or more processes associated with the parking structure such as maximum time allowed for charging at different times/days etc. or assignment of parking slots to SAAVs etc. Additionally, an ACTDEV at the exit can generate a total cost, e.g., parking and/or charging, for payment by the SAAV or a user of the SAAV or vehicle prior to their being granted final exit from the parking structure, e.g., by raising a barrier, dropping an in-road barrier etc.

The information stored within an ACTDEV for a structure, e.g. parking structure, may be automatically generated based upon analysis of the design of the structure from one or more computer based design models for example or it may be mapped and/or generated by one or more individuals or vehicles through acquisition of information from one or more electronic devices as the one or more individuals or vehicles move within the structure. For example, a vehicle may be equipped with sensors to dynamically map the limits of the structure as well as acquire the locations of markers, beacons, ACTDEVs etc.

Within the preceding examples the allocation of a parking spot to a SAAV was described as based upon the ACTDEVs of the parking structure or retail center etc. allocating the spot to the SAAV. This may, have been based, for example, upon determining that a passenger within the SAAV is disabled such that they are routed to a spot near the entrance with enhanced accessibility etc., upon a passenger or user of the SAAV having established a particular retail outlet they wish to visit so that they are routed to a parking spot near that retail outlet rather than another, or the passenger within the SAAV has not defined any preference.

However, the ACTDEVs may communicate additional information to a SAAV such as indications of sales at specific retail outlets, offers from specific retail outlets, a directory of stores and/or services etc. wherein a passenger may establish a retail outlet they wish to visit having not previously established a preference or adjust their previously defined destination. For example, user upon their SAAV entering a parking structure may have previously defined that they wish to visit a specific store for a particular product or product category, e.g., cookware at Store X where the Store X at the location they are visiting has three levels, the parking structure five levels but level 4 of the parking structure has an entrance to Store X upon the level of Store X that has cookware. However, the user may have previously established that they wish to visit Store Y but is advised of a one-day flash sale of cookware at Store X and over-rides their previous selection such that their SAAV is navigated to the appropriate location within the parking structure.

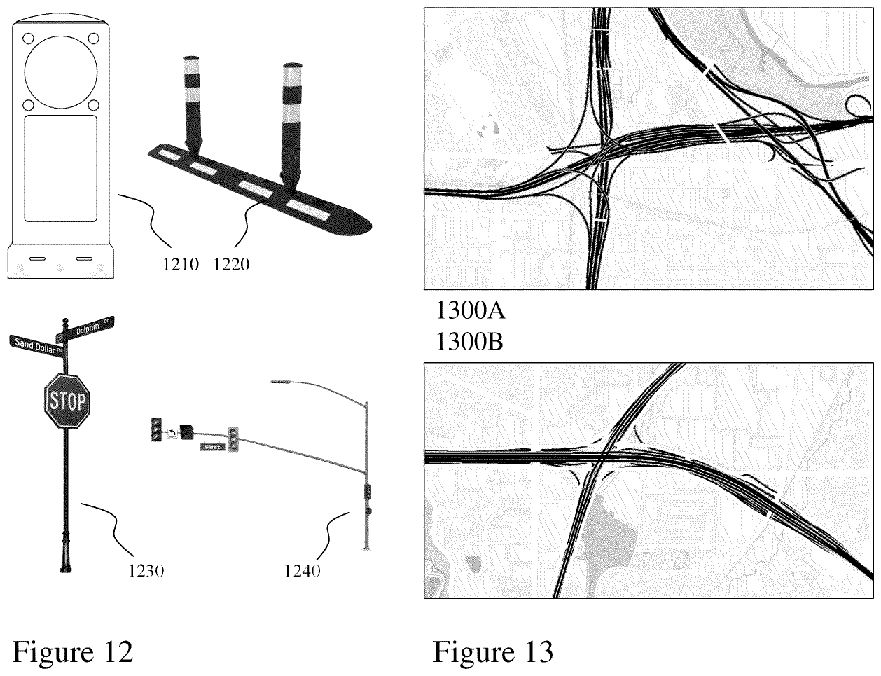

Whilst the exemplary embodiment presented above is with respect to a parking spot within an Indoor Parking Lot 1040 it would be evident that the ACTDEV can provide information to the vehicle relating to a structure, area, etc. not mapped within a mapping database or where the requiring navigation information is dynamically established. For example, such a requirement exists with road construction, road repair or other activities that impact the physical structure of the roadway. As discussed below in respect of FIG. 12 an ACTDEV may be associated with temporary riad infrastructure such as bollards, barriers, etc.

In these scenarios the information stored within the ACTDEV may be mapped dynamically based upon an individual, e.g., a worker or supervisor, scanning the area with an electronic device such that the electronic device acquires the locations of markers, etc. and generates a new mapping of that portion of the roadway such that the ACTDEVs associated with the temporary or semi-permanent adjustment in the layout of the roadway is communicated to vehicles directly or via an intermediate vehicle.

Within other embodiments of the invention the ACTDEV may be associated with other traffic infrastructure such as depicted in FIG. 12 by an installed Bollard 1210, a temporary Roadwork Bollard 1220, Street Sign 1230 and Traffic Lights 1240 as well as other infrastructure either permanent or temporary such as cabinets, bus shelters, barriers, traffic ramps, etc. or attached or built into a building or other structure beside or close to the roadway or roadways the ACTDEV is providing information for. Within embodiments of the invention the ACTDEV may provide mapping functionality whilst markers upon the road surface, kerbs, etc. may provide the actual guidance information for the vehicle to go within the lane. The ACTDEV may also provide additional information required such as maximum speed, minimum speed, that only the right lane should be used when a pair of lanes are detected, etc. Within other embodiments of the invention the ACTDEV may provide both or additional beacons associated with the ACTDEV may provide data for the vehicle to triangulate its location within the area. For example, wireless beacons upon a level within a parking structure may provide triangulation for position whilst an ACTDEV provides mapping and markers provide lane/parking spot identifiers to navigate the vehicle between etc.

Within an embodiment of the invention the ACTDEV may communicate upon a standard predetermined frequency and communications protocol or it may be non-standard, proprietary, or open standard etc. For example, this may be dedicated short-range communication (DSRC) operating within the 5.9 GHz band with a bandwidth of 75 MHz and an approximate range of 1000 m (approximately 3,300 feet).

Within embodiments of the invention an ACTDEV at an exit of an area may acquire data from the vehicle allowing it to verify and/or update its local mapping data, status data for features within the area (e.g., parking spot availability/use) etc. This information may be employed to update local or remote databases wherein it is then provided to other vehicles. The information can be formulated to the standards of the vehicles such as, for example, digital data, a two-dimensional map, a three-dimensional map, coordinates etc. or as variances from previously established data. The vehicle and the ACTDEV may when the information is locally provided establish an electronic handshake and verification/negotiation process with respect to the provisioning/acquisition of the data such as what data is provided, the format, etc. In this manner a delivery SAAV may acquire different information to a passenger SAAV for example.

It would also be evident that ACTDEVs may also be employed at complex traffic intersections or at intersections where satellite navigation signals are blocked, intermittent, or subject to multiple reflections etc. For example, referring to first and second Images 1300A and 1300B respectively there are depicted complex highway intersections where roadways pass under others such that GPS signals are blocked and the concrete/metal within the structures result in signal attenuation, multiple reflections etc. Accordingly, ACTDEVs may be positioned at points ahead of the junction for a specific lane wherein the ACTDEV provides information relating to the layout of the structure. In first Image 1300A the junction has four (4) levels whereas the junction in second Image 1300B the junction has five (5) levels such that even if GPS signals are received the VCU may be confused as to which roadway it is actually on as the same GPS location (omitting vertical data) matches 4 or 5 roadways respectively in first and second Images 1300A and 1300B.

It would be evident that ACTDEVs may link together to provide the necessary information for on-coming traffic either sequentially between adjacent ACTDEVs or to preceding predetermined ACTDEVs. This information may include data to slow down or speed up traffic, advise of an accident, advise of road conditions, etc. For example, an ACTDEV may communicate to an adjacent ACTDEV road conditions or speed adjustments but might communicate to another ACTDEV associated with a preceding junction in the event of an accident affecting a traffic direction bypassing additional intermediate ACTDEVs along the route. Alternatively, rather than direct ACTDEV to ACTDEV communications the routing may be managed by another layer within the overall network associated with control.

ACTDEVs may be positioned at points after the junction for a specific lane wherein the ACTDEV retrieves information from vehicles thereby acquiring data from the vehicles relating to the layout of the structure based upon the navigation data from the VCUs etc. of the vehicles.

Within other embodiments of the invention a self-contained or networked ACTDEV may identify an approaching vehicle, receive a discovery signal from the approaching vehicle, or be provided with arrival information from the network to which the ACTDEV and vehicle are connected. Once the ACTDEV identifies the vehicle then the ACTDEV either replies with predetermined information, such as described above with respect to navigation information etc., or replies with information established in dependence upon the vehicle and/or a status of a structure or object ahead of the vehicle with which the ACTDEV is associated.

For example, upon a portion of a roadway comprising a banked turn the ACTDEV may trigger a speed notification to a truck or van to reduce the likelihood of the vehicle tipping over whereas this speed notification would not be required for a passenger car, motorcycle etc. Alternatively, the ACTDEV may trigger an automatic reduction or adjustment in the SAAV route such that for example a high sided SAAV is routed to an outer lane of the banked turn such that any incident results in the high sided SAAV tipping away from the other lanes whereas a low sided SAAV may be routed to any of the lanes. In doing so the ACTDEV may adjust other vehicles directly or indirectly in terms of route, lane, speed etc. through communications between vehicles once it has been transmitted to one or more SAAVs.

Within another non-limiting example the ACTDEV is associated with a bridge, sign, tunnel, overhang etc. and may trigger a speed reduction for some vehicles (e.g. trucks and vans below a defined height limit), no notification for others (e.g. passenger cars), and a stop for other vehicles (e.g. trucks above the defined height limit) in order to prevent a collision with the coming object. The ACTDEV may also trigger a display or notification (e.g., trigger the vehicles horn) in the case of non-autonomous vehicles to alert the driver.

Within embodiments of the invention the ACTDEV may measure the height, width of an approaching vehicle in order to establish the height, width of the vehicle to either verify the information it receives (e.g. to ensure the vehicle is not towing a tall trailer for example or a truck or trailer has been loaded to a height exceeding that the vehicle has stored within its characteristics that it provides to the ACTDEV. If the ACTDEV determines an issue then it can issue a communication to the SAAV to control the SAAV or to a non-autonomous vehicle as an alert

Within embodiments of the invention an ACTDEV on the vehicle may measure the height, width of an approaching objects (e.g. overhead bridge, overhanging sign, distance between bollards, an end of the road etc.), via various methods, e.g. optical and/or RF in order to establish height, width of the object(s) to see if clearance will be an issue for the vehicle to pass though especially for the high and/or wide vehicles. In addition, the ACTDEV devices associated with the roadway may also establish or compare the information to verify information it receives or to override a control of the vehicle.

For example, a bridge may be arched with two lanes under in, one in either direction. A maximum safe height for a vehicle on each one of the lanes under the arch is 8 feet. However, if a vehicle under 10 feet wide traverses the middle of the bridge arch by straddling both lanes then a maximum height of 12 feet may pass. Accordingly, an ACTDEV may detect the presence of a SAAV with a height of 11 feet and direct the SAAV to traverse the middle of the arch wherein the ACTDEV associated with the bridge arch may stop other traffic to allow the vehicle to go under the arch of the bridge. Alternatively, the ACTDEVs may require the SAAV to park, wait for a suitable point to disable traffic flow and then allow the SAAV to pass.

According to an embodiment of the invention there is provided a vehicle with communication interface(s) to receive information from a system of ACTDEVs located with respect to roadway the vehicle is traversing upon. The vehicle may be acquiring road information, e.g., from Markers 450, as well data from the ACTDEVs whereby the VCU of the vehicle processes this information which is then employed by the VCU and/or other systems of the vehicle to provide for semi-autonomous or autonomous control of the vehicle. The VCU may also pass this information to a navigation database system for storage and/or updating the navigation database system for a subsequent re-traversal of the road by the vehicle. The VCU may also transmit data relating to a portion of the navigation database system to the ACTDEVs or a subset of the ACTDEVs in order to either update the databases associated with the ACTDEVs and/or for transmission to other vehicles, e.g. by passing the data to one or more prior ACTDEVs to update vehicles travelling in the same direction or to one or more subsequent ACTDEVs to update vehicles travelling in a contra-direction.

Within embodiments of the invention for a non-SAAV vehicle or semi-autonomous vehicle information from an ACTDEV, e.g., information of not clearing the height and/or width of an object ahead will trigger one or more warning signals (e.g., visual and/or auditory) to the driver. Further, the control system and/or ACTDEV may upon a lack of action by a driver of a non-SAAV either cause the non-SAAV to brake and stop and/or pull over to a safe location for the driver to assess the situation.

Within other embodiments of the invention the trigger for these alerts to a driver of a non-SAAV may be based upon other factors even when a trigger for a height/width etc. is not generated. For example, a driver may be alerted that they are going to cross over a bridge when the temperature is below a predetermined threshold as there is an increased likelihood of ice on the roadway. Other triggers may be generated from factors such as low visibility, inclement weather, and low light for example. Within other embodiments of the invention a user of a non-SAAV or semi-autonomous vehicle may be provided with an alert to a degradation or failure within one or more sensor systems of the or a failure of one or more systems of the non-SAAV or semi-autonomous vehicle.

### Sensor and/or Transceiver Cleaning

Within FIG. 3 there are depicted locations for air collectors for a vehicle which are associated with power generation for the vehicle. However, within other embodiments of the invention these locations, together with others, may be locations for the deployment of sensors and/or transceivers for communications which are associated with the vehicle. These sensors may be microwave based sensors, optical based sensors, or environmental sensors for example.

Accordingly, one or more sensors and/or one or more transceivers for communications may be associated with a Rear Light Cluster 310, a Rear Body Panel 320, a Roof Panel 330, a Mirror 340, an Air Intake Vent 350 (e.g. as part of the air management system of the air for the passengers within the vehicle), a Front Grille 360, a Body Grille 365, a Side Panel 370, an Underside 380, and a Front Light Cluster 390 for example.

Such sensors and/or transceivers may have their performance degraded or stopped by debris, such as dirt, mud, snow, water, ice etc. With non-autonomous vehicles such degradations or failures can be frustrating but for SAAVs these degradations or failures can lead to collisions, accidents or result in the SAAV automatically terminating its operation. Accordingly, the sensors and/or transceivers require protection, cleaning etc. to limit the degradation arising from the debris such as dirt, mud, snow, water, ice etc.

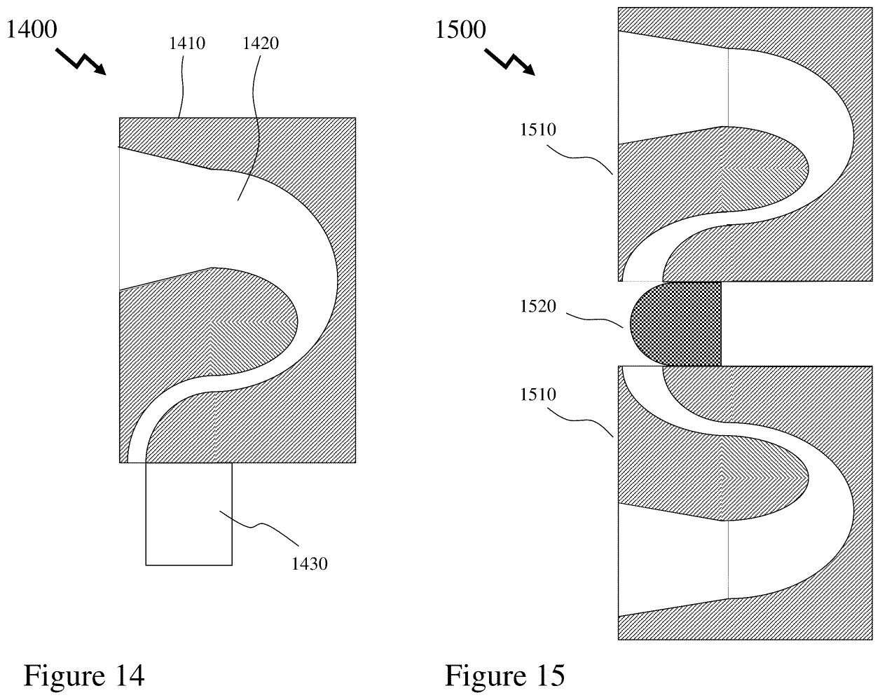

Referring to FIGS. 14 and 15 there are depicted exemplary air flow deflectors for cleaning sensors and/or transceivers of debris. Referring to FIG. 14 a Sensor Module 1400 comprising an Air Deflector 1410 is disposed with respect to a sensor and/or transceiver (SENTRA) 1430 wherein air flows into the Air Deflector 1410 from motion of the vehicle where the Bore 1420 acts to increase the velocity of the air before it impacts upon the SENTRA 1430 in order to remove dust, water, and other debris from the SENTRA 1430. Optionally, multiple Air Deflectors 1410 may be employed with a single SENTRA 1430 or with multiple SENTRAs 1430.

In FIG. 15 a Sensor Module 1500 comprises a pair of Air Deflectors 1510 which are disposed with respect to a SENTRA 1520 wherein air flows into the Air Deflectors 1510 from motion of the vehicle where the bores within the Air Deflectors 1510 act to increase the velocity of the air before it impacts upon the SENTRA 1520 in order to remove dust, water, and other debris from the SENTRA 1520. Optionally, multiple Air Deflectors 1510 may be employed with a single SENTRA 1520 or with multiple SENTRAs 1520. Optionally, the Air Deflector 1510 depicted in FIG. 15 is depicted in cross-section and has a symmetric radial profile such that the Air Deflector 1510 is circularly symmetric with respect to the SENTRA 1520. Alternatively, the Air Deflector 1510 surrounds the SENTRA 1520 with a non-radially symmetric geometry.

Within FIGS. 14 and 15 the air flow is induced through kinetic motion of the vehicle. However, it may be induced through one or more fans, turbines, etc. discretely or in combination with kinetic air flow induced by the vehicle's motion.

Within embodiments of the invention this air flow induced from one or more fans may be provided a low vehicle speeds as kinetic air flow induced by the vehicle's motion is sufficient at higher speeds. For example, the fan induced air flow threshold may be 10 km/h, 30 km/h etc.

Within other embodiments of the invention one or more cleaning solutions and/or water may be atomized and added to the air flow continuously or periodically. Within embodiments of the invention vents within the Air Deflectors may adjusted in dependence upon a speed of the vehicle.

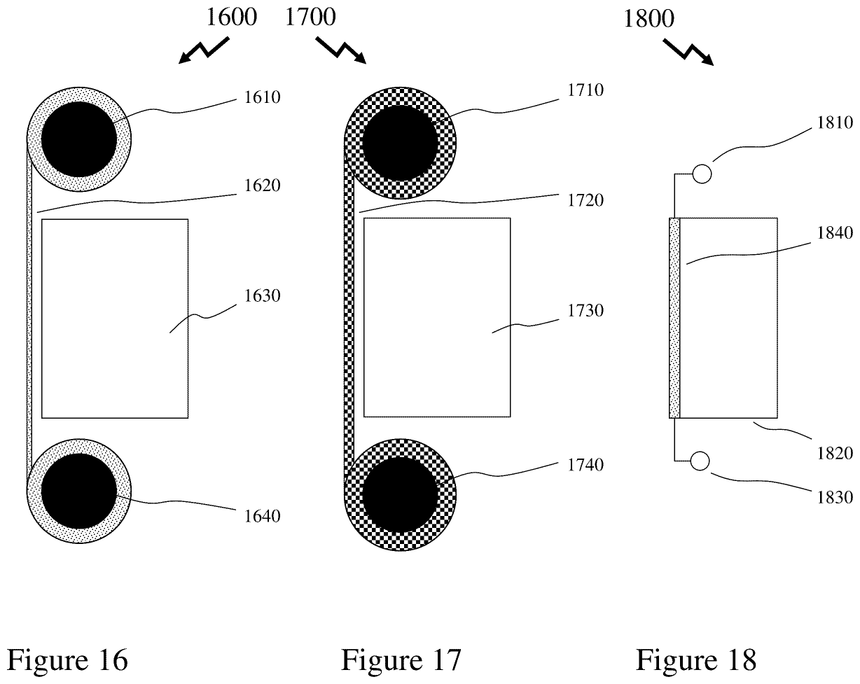

Now referring to FIG. 16 there is depicted a replaceable Sheet 1620 for protecting a sensor SENTRA 1630 from debris. The Sheet 1620 is disposed between an Upper Roller 1610 and a Lower Roller 1640, one or both of which are motorized, such that the Sheet 1620 can be moved across the front of the SENTRA 1630. The decision upon when to move the Sheet 1620 relative to the SENTRA 1630 may be established in dependence upon one or more factors including, but not limited to, an elapsed time since prior movement of the Sheet 1620 and monitored degradation in the performance of the SENTRA 1630. The Sheet 1620 may be disposed within a cartridge that can be replaced periodically upon “depletion” of the Sheet 1620, i.e., when all of the Sheet 1620 has been exposed.

Referring to FIG. 17 there is depicted a replaceable Filter 1720 for protecting a sensor SENTRA 1730 from debris. The Filter 1720 is disposed between an Upper Roller 1710 and a Lower Roller 1740, one or both of which are motorized, such that the Filter 1720 can be moved across the front of the SENTRA 1730. The decision upon when to move the Filter 1720 relative to the SENTRA 1730 may be established in dependence upon one or more factors including, but not limited to, an elapsed time since prior movement of the Filter 1720 and monitored degradation in the performance of the SENTRA 1730. The Filter 1720 may be disposed within a cartridge that can be replaced periodically, i.e., when all of the Filter 1720 has been exposed.

Now referring to FIG. 18 there is depicted a thin film Heater 1840 for protecting a SENTRA 1820 from ice or snow, for example. The Heater 1840 being coupled to first and second Electrical Connections 1810 and 1820, respectively. The decision upon when to activate the Heater 1820 may be established in dependence upon one or more factors including, ambient temperature, ambient environmental conditions, and a surface resistance measurement on front of the SENTRA 1820.

Within FIGS. 14 to 18 methods of cleaning SENTRAs are depicted in order to reduce the impact of debris. However, within other embodiments of the invention the SENTRAs may be disposed behind a window of the vehicle, e.g., front windscreen, rear windscreen, side window etc. For example, current DAS systems such as lane keeping assistance, lane centering assistance, and semi-automatic beam switching of headlights employ a camera disposed at the top centre of the front windscreen. However, this region of the front windscreen is at the outer edge of the region swept by windscreen wiper(s) of the vehicle. Accordingly, with an increasing number of SENTRAs for semi-autonomous and autonomous vehicles, ensuring that the regions of the front windscreen, rear windscreen, side window etc. where these SENTRAs are disposed are clear of debris becomes increasingly important.

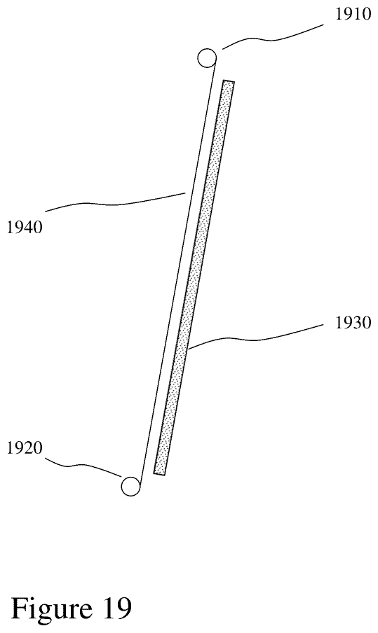

Accordingly, referring to FIG. 19 there is depicted a cleaning system for clearing the entire windscreen of a vehicle. As depicted a Wiper 1940 is disposed in front of a Window 1930, e.g., a front windscreen, a rear windscreen, or a side window, and coupled to an Upper Mounting 1910 and Lower Mounting 1920. Each of Upper Mounting 1910 and Lower Mounting 1920 comprising a rail allowing the Wiper 1940 to move across the Window 1930. One or both of the Upper Mounting 1910 and Lower Mounting 1920 may be motorized in order to move the Wiper 1940 across the Window 1930. Accordingly, the Wiper 1940 traverses the Window 1930 to clean it wherein the Wiper 1940 comprises a flexible blade, a flexible brush etc. A cleaning solution dispensing system may be associated with one or more of the vehicle, the Upper Mounting 1910, the Lower Mounting 1920, and Wiper 1940 in order to dispense a cleaning solution upon the Window 1930 as the Wiper 1940 cleans the Window 1930.

Alternatively, the Wiper 1940 may incorporate one or more positive air flow nozzles to blow air onto the Window 1930 and/or one or more negative air pressure nozzles to suck air and debris away from the Window 1930.

Optionally, within other embodiments of the invention the Wiper 1940 may include one or more heating elements to facilitate easy cleaning of debris or harsh weather elements like ice and snow from the Window 1930.

A motor moving the Wiper 1940 may be controlled from the VCU or another control system of the vehicle either through manual adjustments or automatically adjusted upon one or more factors of the vehicle such as speed, temperature, ambient environmental conditions, etc. Optionally, additional one or more other motors may adjust the pressure or other parameters of the Wiper's 1910 engagement with the Window 1930.

Optionally, the system according to embodiments of the invention the Wiper 1940 may comprise multiple Wipers 1910 acting at once in concert with one another or subsets of the multiple Wipers 1910 may be acting at once with different placement(s), speed(s), etc.

The Wiper(s) 1910 may be replaceable as are the Upper Mounting 1910 and the Lower Mounting 1920. The Wiper(s) 1910 may be snapped into position or employ simple fastener(s) to prevent tampering. Optionally, the Upper Mounting 1910 and the Lower Mounting 1920 elements of the system may be concealed within bodywork of the vehicle for improved aesthetics and/or protection from environmental elements.

### Automated Ticketing

Violating traffic laws or parking restrictions etc. are cumbersome as the majority of these are based upon manual processes from parking wardens, police enforcement etc. For example, time based parking infractions on streets are based upon a manual process where a bylaw officer will mark a tire of every vehicle then return after a predetermined period of time as defined by the parking restrictions at that point in time. Infractions of parking in areas where no parking is allowed are easier to monitor as are speed infractions in regions where radar based traffic monitoring is employed or traffic light infractions where cameras are triggered when data from the lights indicates they are red for example.

An autonomous vehicle may, by its specific design, control itself such that its maximum and/or minimum speeds are within the limits for a current roadway it is traversing. However, in many instances a driver of a non-autonomous or a semi-autonomous vehicle will “gamble” that their infraction will go unmonitored as the number of law enforcement officers for an area may be few or they are spread over a large area. Accordingly, it would be beneficial to leverage ACTDEVs and/or in-vehicle systems to enforce traffic laws, parking limits etc.

For example, an ACTDEV associated with a parking structure or area may within the data stored by it, either upon installation or subsequently provided to or acquired by it, include time/date settings indicating allowed parking periods, e.g., between 9 am-11 pm Monday-Friday in May-November and 9 am-8 pm Monday-Friday December-April. Accordingly, the ACTDEV can establish the presence of a vehicle within the parking structure, establish data relating to the vehicle (e.g. optical character recognition of number plate or by wireless interrogation of a VCU or ECU or other electronic systems of the vehicle), determine validity of the parking and automatically transmit data relating to an infraction to a remote server for processing whereby if appropriate an infraction notice and/or penalty are communicated to a user and/or address associated with the vehicle.

It would be evident that such an automated parking infraction system would allow for escalating penalties or other penalty structures. For example, an initial penalty may be defined for a first period after a period of valid parking and then subsequent penalties may be defined for subsequent periods of time. Within another embodiment of the invention an ACTDEV may communicate to an enforcement vehicle such that the infringing vehicle is removed, e.g., it is blocking a lane of a road when allowable parking has ceased, allowing for eased traffic flow.

Within other embodiments of the invention ACTDEVs by communicating with a vehicle or identifying a vehicle and communicating this information to a remote system can establish timing/speed information for the vehicle thereby allowing for an automated determination of whether the vehicle is breaking any speed limit. Similarly, by extracting information from the navigation system(s) of the vehicle a remote system communicating with the vehicle via ACTDEVs may determine whether a driver of the vehicle has performed any dangerous maneuvers.

Within embodiments of the invention ACTDEVs may be stationary, mobile, handheld, mounted on a vehicle, form part of roadway infrastructure, form part of traffic management infrastructure, etc.

### Lighting

Currently, in the market, there are no recessed lighting fixtures which can be classed as fire retarding as the materials employed in them transfer heat from the fire or fail under exposure to the heat of the fire. A recessed lighting fixture comprises a housing, a light bulb, wires, a baffle, and a junction box.

The housing of a lighting fixture according to embodiments of the invention may be formed from one or more materials selected from the group comprising a metal, an alloy, a ceramic, a high temperature polysiloxanes, carbon fiber, fiberglass, potassium silicate, corrugated polypropylene, calcium silicate in any shape or style. For example, the housing materials can be formed in any shapes or styles from one or more of ceramic, a high temperature polysiloxane, carbon fiber, and fiberglass coated with potassium silicate or other fire-retardant material(s).

The wires may be cabled with flame retardant materials rather than a plastic and.or be coated with a flame retardant.

Within the following description emphasis is placed upon Semi-Autonomous and Autonomous Vehicle (SAAV) Systems, Applications and Platforms (SAAV-SAPs) where these vehicles are land based vehicles, commonly passenger vehicles. However, it would be evident that within other embodiments of the invention these SAAV-SAPs exploiting or implementing embodiments of the invention may be applied to other vehicles both land based and non-land based.

Further, some embodiments of the invention may be applied to vehicles that are not SAAVs such that these embodiments of the invention may be applied to vehicles ranging from Level 0 to Level 5 of Society of Automotive Engineers (SAE) definitions of driving automation or any other range/scale/definition relating to manual to automated control, direction and decision making within vehicles.

It would also be evident to one of skill in the art that embodiments of the invention whilst being described above with respect to vehicles may also be applied to pedestrians with respect to aiding their navigation upon or within the vicinity of roadways etc. For example, just as a vehicle may obtain data from an ACTDEV allowing it to navigate within an area, e.g. parking infrastructure, then a pedestrian, a passenger of the vehicle etc. may also obtain information from the ACTDEV. For example, the passenger of the vehicle may be provided navigation directions out of the parking structure in this example discretely or also be provided navigation directions back to the vehicle within the parking structure.

In a similar manner a pedestrian may be periodically provided with information relating to their navigation. For example, a pedestrian may be advised that due to temporary roadworks ahead the path they are currently on ends before the next junction wherein they could have swapped side of the road to walk down etc. and hence it would be beneficial for them to swap sides of the road now or be provided with an alternate path around the temporary roadworks. Similarly, a pedestrian may be navigated through a parking structure etc. to shorten their journey rather than routed around it or navigated to a location within the parking structure etc., e.g. a public transit stop (e.g. bus, tram, rail, etc.) or a public transit station etc. Within other embodiments a user exploiting such embodiments of the invention may be upon mechanized or non-mechanized transport such as motorcycle, scooter, bicycle, skateboard, etc.

Within another embodiment of the invention a non-vehicle based user may transmit information to an element of infrastructure such that the infrastructure adjusts temporarily in dependence upon the information received from the user. For example, a set of traffic lights may provide pedestrians with 30 seconds to cross from one side to the other but a user may require longer, e.g. if the user elderly, temporarily or permanently disabled, walking with infants etc. Accordingly, the user's PED may communicate with the traffic lights temporarily adjusting the cycle such that the user is given 45 seconds to cross, for example. The infrastructure could then adapt the other elements to align with this discretely or it could communicate to the SAAVs etc. such that, if these are working from a previously communicated signaling change/sequence their control systems are updated with the new signaling change/sequence etc. Within other embodiments of the invention rather than the requirement being automatically transferred to the infrastructure from the user's PED the user may trigger the request for an adjustment, e.g. today they are walking with an elderly relative, an infant etc. whereas this is not normally the case. This may allow for the user to trigger infrastructure adjustments without adjusting the configuration of their PED thereby allowing for dynamic instances, such as meeting someone part way through a journey etc.

In a similar manner an element of infrastructure may detect the presence of a user, determine that they are stationary for a predetermined period of time, and then trigger the infrastructure to act. For example, a pedestrian crossing which today requires manual triggering may be automated. The infrastructure may interrogate the user's PED, for example, such that as they approach the infrastructure it determines that they are being navigated by a software application in execution upon their PED which will require them to use that item of infrastructure and accordingly the infrastructure can adapt to the user's approach stopping traffic such that pedestrian traffic flow is prioritized over vehicle traffic flow for example. Optionally, an element of infrastructure may automatically count pedestrians waiting and adjust timing on the basis that larger groups of pedestrians will take longer to cross.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels and/or various other mediums capable of storing, containing, or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g., software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. The method according to claim 34; further comprising defining a region of a surface for traversal by a vehicle comprising providing a plurality of markers in a predetermined pattern upon the region of the surface;
determining by an electronic device forming part of the vehicle the region of the surface in dependence upon processing signals received from a subset of the plurality of markers; wherein
the signals received from the subset of the plurality of markers are received by the receiver forming part of the vehicle.

2. The method according to claim 1, wherein one of:
the receiver is a radio frequency (RF) receiver;
the signals received from the subset of the plurality of markers are signals generated in dependence upon a RF transmitter forming part of the vehicle; and
each marker of the plurality of markers comprises at least one of a paint based marker with one or more metallic elements embedded within the marker and a metallic paint; and
the receiver is a radio frequency (RF) receiver;
the signals received from the subset of the plurality of markers are signals generated in dependence upon a RF transmitter forming part of the vehicle; and
each marker of the plurality of markers comprises at least one of a RF emitter which emits a RF signal in response to a received RF signal from the RF transmitter and a reflective microwave circuit which emits another RF signal generated by receiving and processing the RF signal from the RF transmitter.

3. (canceled)

4. The method according to claim 1, wherein
the receiver comprises one or more optical detectors;
the signals received from the subset of the plurality of markers are signals generated in dependence upon an optical signal from a transmitter forming part of the vehicle;
each marker of the plurality of markers comprises at least one of:
an optical emitter which emits in response to detecting a signal from the transmitter where the transmitter is a radio frequency (RF) transmitter;
an optical emitter which emits in response to detecting motion of the vehicle;
an optical emitter which emits in response to detecting optical signals from the transmitter where the transmitter is a headlight of the vehicle;
the optical emitter is one of an ultraviolet emitter, an infrared emitter, and a visible emitter; and
each marker of the plurality of markers comprises an optically reflective marker which receives an optical signal from the transmitter and reflects a predetermined portion of the optical signal where the predetermined portion of the optical signal reflected is established in dependence upon a direction of the optical signal relative to the marker.

5. (canceled)

6. The vehicle according to claim 35, wherein:
the sub-system comprises:
a first battery system for providing electricity to a motor of the vehicle;
one or more second battery systems each coupled to an electrical control system of a plurality of electrical control systems of the vehicle; and
upon determining the first battery system has dropped below a predetermined charge threshold establishing one or more actions with a subset of the plurality of electrical control systems.

7. The vehicle according to claim 6 wherein at least one of:
an action of the one or more actions of the subset of the plurality of electrical control systems with respect to the vehicle is selected from the group comprising applying a brake of the vehicle, navigating the vehicle to a parking spot, and navigating the vehicle from of a current traffic lane of a roadway the vehicle is currently in to a non-traffic lane of the roadway;
an electrical control system of the plurality of electrical control systems is a controller of a visual indicator of the vehicle which is one of a brake light or indicator light of the vehicle and an action of the one or more actions is establishing the visual indicator into generating a predetermined lighting pattern; and
a first electrical control system of the plurality of electrical control systems is a controller of a visual indicator of the vehicle, a second electrical control system of the plurality of electrical control systems is a controller of a brake of the vehicle, the visual indicator is one of a brake light or indicator light of the vehicle, a first action of the one or more actions is establishing the visual indicator into generating a predetermined lighting pattern and a second action of the one or more actions is applying the brake of the vehicle.

8-10. (canceled)

11. The vehicle according to claim 35, wherein
the sub-system comprises:
one or more at least one of air collectors and air concentrators each comprising an inlet and an outlet; and
an air turbine electrical generator coupled to the outlets of the one or more at least one of air collectors and air concentrators; wherein
air flow through the one or more at least one of air collectors and air concentrators generates electrical power for the vehicle via the air turbine electrical generator.

12. The vehicle according to claim 11, wherein at least one:
the sub-system further comprises a heating element associated with one of the air turbine electrical generator and the one or more at least one of air collectors and air concentrators wherein the heating element is turned on when either an ambient temperature or the ambient temperature adjusted for a current speed of the vehicle is below a predetermined threshold; and
each of the one or more at least one of air collectors and air concentrators employs one or more Venturi effect elements to accelerate the air flow from the inlet to the outlet; and
the one or more at least one of air collectors and air concentrators are integrated into one of a rear light cluster, a rear body panel, a roof panel, a mirror, an air intake vent forming part of an air management system of the vehicle, a front grille, a body grille, a side panel, an underside, and a front light cluster.

13. (canceled)

14. The method according to claim 36, wherein
the charging system comprises a plurality of replenishing stations supporting recharging of the SAAV; and
the method further comprises:
determining arrival of the SAAV within the vicinity of the plurality of replenishing stations supporting recharging of the SAAV;
executing one of a first sub-process and a second sub-process; and
automatically navigating the SAAV to the specified replenishing station location then updating the status of the replenishing station so that it does not provide it to another vehicle until it has verified that the SAAV has recharged and departed;
the first sub-process comprises:
broadcasting a first message from the SAAV indicating SAAV requirements for recharging;
identifying, with an electronic device associated with the plurality of replenishing stations an identity of a specific replenishing station of the plurality of replenishing stations that can provide the requirements of the SAAV which is currently empty of a SAAV; and
transmitting a message from the replenishing station comprising data relating to the specific replenishing station the plurality of replenishing stations; and
the second sub-process comprises:
broadcasting data to the SAAV from an electronic device associated with the plurality of replenishing stations;
identifying, with another electronic device associated with the SAAV an identity of a specific replenishing station of the plurality of replenishing stations that can fulfil a requirement of the SAAV for recharging:
transmitting a message from the SAAV to the specific replenishing station the plurality of replenishing stations to reserve a charging slot at the specific replenishing station the plurality of replenishing stations.

15. The method according to claim 14, wherein
in the first sub-process the data relating to the specific replenishing station the plurality of replenishing stations comprises at least one of location data and marker data required by the SAAV to navigate to the specific replenishing station the plurality of replenishing stations; and
in the second sub-process the data comprises at least one of:
capacities of currently empty replenishing stations of the plurality of replenishing stations;
projected times to replenishing stations of the plurality of replenishing stations becoming free with a required capacity for the SAAV; and
identities of replenishing stations of the plurality of replenishing stations capable of providing sufficient capacity for the SAAV to navigate to another replenishing station location with the requested capacity or another replenishing station location.

16-17. (canceled)

18. The method according to claim 36, wherein
the charging system comprises a container based replenishing station for a vehicle comprising:
a source of fuel to replenish the vehicle;
an electronic device coupled to a network for providing data to a remote server; and
a plurality of markers; and
the plurality of markers are employed by the vehicle to maneuver into a correct position such that the vehicle can replenish with the fuel.

19. The method according to claim 18, wherein
at least one of:
the electronic device provides the remote server with at least one of location data of the container based replenishing station and wireless communications of data relating to the replenishment of vehicles;
the plurality of markers comprises one or more strips of markers where each strip of markers comprises markers in a predetermined pattern and each strip of markers is deployed in a defined position and defined orientation relative to the container based replenishing station;
the plurality of markers comprises a mat of markers in another predetermined pattern where the mat of markers is deployed in defined position and orientation relative to the container based replenishing station; and
the plurality of markers are one of a slide out from the container based replenishing station and are part of a panel of the container based replenishing station that hinges down when the container based replenishing station is deployed.

20. (canceled)

21. The method according to claim 18, wherein the source of fuel is at least one of:
electrical power provided by one of a plurality of batteries;
electrical power provided by a nuclear powered electrical generator;
electrical power provided by one of a plurality of batteries which are recharged by one of a solar panel, a wind turbine, and a water turbine;
hydrogen from a hydrogen generator or hydrogen storage tank;
gasoline from a gasoline tank; and
diesel from diesel storage tank.

22-23. (canceled)

24. The method of navigating a vehicle according to claim 34; further comprising:
providing an active device associated with a location within which the vehicle will navigate;
transmitting to the receiver of the vehicle from the active device a navigation file associated with the location; and
navigating the vehicle in dependence upon the signals received with the receiver comprises navigating the vehicle within the location in dependence upon data within the navigation file.

25. The method according to claim 24, wherein
at least one of:
the location is one where establishing a location of the vehicle by a global positioning system or cellular wireless based determination is unobtainable or not possible;
the location was previously identified within a mapping database accessible to or stored within a memory of the vehicle as a generic block without specific data;
the location is a parking structure previously identified within a mapping database accessible to or stored within a memory of the vehicle as a generic block without specific data;
the navigation file is transmitted in dependence upon at least one of identifying an approach of the vehicle towards the active device and the vehicle seeking access to the location; and
the location is a parking structure and the navigation file comprises navigation data to a defined parking spot within the parking structure.

26-29. (canceled)

30. The method according to claim 24, wherein
the location is a site of roadworks;
the navigation file defines either a current layout of the location or differences between the location prior to the roadworks and its current status; and
the active device is associated with a movable element selected from the group comprising a bollard, a barrier, and a sign.

31. The vehicle according to claim 35, wherein
the sub-system comprises:
at least one of a sensor and a transceiver;
an air deflector comprising an inlet and an outlet;
the outlet of the air deflector directs air flow existing the outlet to impact upon the at least one of a sensor and a transceiver to remove at least one of dust, water, and debris from the at least one of the sensor and the transceiver; and
each air deflector of the one or more air deflectors increases a velocity of air from the inlet to the outlet.

32. The vehicle according to claim 31, wherein at least one of:
the air deflector is one of a plurality of air deflectors disposed around the at least one of the sensor and the transceiver; and
the air deflector surrounds a periphery of the at least one of a sensor and a transceiver.

33. (canceled)

34. A method of navigating a vehicle comprising:
providing a receiver forming part of the vehicle; and
navigating the vehicle in dependence upon signals received with the receiver.

35. A vehicle comprising:
a sub-system.

36. A method of recharging a semi-autonomous or autonomous vehicle (SAAV) comprising:
providing a charging system.
